(19) United States
(12) Patent Application Publication
(10) Pub. No.: US 2025/0224331 A1
(43) Pub. Date: Jul. 10, 2025

(54) METHOD, SYSTEM AND SENSOR FOR ANALYSING A SAMPLE, AND PROCESS FOR MANUFACTURING AN ELECTRODE

(71) Applicant: TeraView Limited, Cambridge, Cambridgeshire (GB)

(72) Inventors: Ian Alasdair Pentland, Cambridge (GB); Philip Francis Taday, Cambridge (GB); Donald Dominic Arnone, Cambridge (GB); Bryan Edward Cole, Cambridge (GB)

(73) Assignee: TeraView Limited, Cambridge, Cambridgeshire (GB)

(21) Appl. No.: 18/853,067

(22) PCT Filed: Mar. 31, 2023
(86) PCT No.: PCT/GB2023/050868

§ 371 Date: Sep. 30, 2024

(30) Foreign Application Priority Data
Mar. 31, 2022 (GB) 2204744.3

(51) Int. Cl. G01N 21/3581; G01B 11/06; G01N 21/41; G01N 21/84

(52) U.S. Cl. CPC G01N 21/3581; G01B 11/0625; G01N 21/41; G01N 21/8422; G01N 2021/8427

(57) ABSTRACT

A method for analysing a sample comprising a layer having a first interface and a second interface, the method comprising: Irradiating the sample with a pulse of terahertz radiation, said pulse comprising a plurality of frequencies in the range from 0.01 THz to 10 THz; Detecting radiation reflected from the sample to produce a sample waveform; Obtaining a first reflection waveform from the sample waveform, the first reflection waveform corresponding to the reflection from the first interface; Obtaining a second reflection waveform from the sample waveform, the second reflection waveform corresponding to the reflection from the second interface; Comparing the first reflection waveform with the second reflection wave-form to produce an estimate of a thickness and a complex refractive index of the layer; Producing a synthesised signal using the estimate of the thickness and complex refractive index; Varying at least one of the thickness and complex refractive index to reduce an error between the sample waveform and the synthesised signal; and Outputting the thickness of the layer.

### FIELD

Embodiments of the present invention relate to a method, a system, and a sensor for analysing a sample, and a process for manufacturing an electrode. In particular, the method, system, sensor, and process use terahertz radiation.

### BACKGROUND

Terahertz radiation is a non-invasive method of determining the internal structure of an object and the thickness of its layers. For example, terahertz radiation may be used to measure the properties of a sample comprising one or more layers.

When a terahertz beam is interacts with a sample, the beam may be altered. The properties of the sample may be determined from the altered beam.

Terahertz time-domain spectroscopy is a technique where a terahertz pulse is applied to a sample and waveform data in the form of a signal as a function of optical delay is obtained.

There is a need for improved methods and systems for measuring the properties of a sample using terahertz radiation. In particular, there is a need for improved methods and systems when the sample has a high absorption and/or high refractive index.

### BRIEF DESCRIPTION OF FIGURES

Embodiments of the invention will now be described, by way of example only, with reference to the accompanying drawings in which:

FIG. 1(a) shows a schematic illustration of analysing a sample using a reflected beam;

FIG. 1(b) shows a schematic illustration of analysing a sample using a transmitted beam;

FIG. 2 shows a schematic illustration of analysing a sample by irradiating the sample with terahertz radiation and measuring the reflection;

FIG. 3 shows a schematic illustration of system for analysing a sample;

FIG. 4 shows a schematic illustration of a method for analysing a sample according to an embodiment;

FIG. 5 shows a schematic illustration of obtaining an estimate of the thickness and/or complex refractive index of a layer;

FIG. 6(a) shows a plot of the signals obtained from a reference sample and from a sample comprising a layer;

FIG. 6(b) shows a schematic illustration of time gating a time domain signal;

FIG. 6(c) shows a schematic illustration of estimating the real part of the refractive index;

FIG. 6(d) shows a schematic illustration of estimating the real part of the refractive index;

FIG. 6(e) shows a plot of a deconvolved waveform;

FIG. 6(f) shows a schematic illustration of a method for obtaining a reflection spectrum;

FIG. 6(g) shows a schematic illustration of a method for obtaining a reflection spectrum;

FIG. 6(h) shows a schematic illustration of a method for obtaining a thickness and the absorption and/or imaginary part of the refractive index;

FIG. 6(i) shows a schematic illustration of fitting the refractive index to a model;

FIG. 7 shows a schematic illustration of a method for analysing a sample according to an embodiment;

FIG. 8(a) shows a plot of a reflection waveform obtained from a substrate;

FIG. 8(b) shows a plot of a reflection waveform obtained from a cathode;

FIG. 8(c) shows a plot of a reflection waveform obtained from an anode;

FIG. 9(a) shows a schematic illustration of a beam focussed at a surface of a substrate;

FIG. 9(b) shows a schematic illustration of the change in the focus of the beam of FIG. 9(a) when a layer is introduced;

FIG. 9(c) shows a schematic illustration of a beam width as a function of distance;

FIG. 10(a) shows an illustration of the reflection waveform when using an optical system with a large f-number;

FIG. 10(b) shows an illustration of the reflection waveform when using an optical system with a small f-number;

FIG. 11(a) shows a schematic illustration of the internal configuration of a terahertz sensor;

FIG. 11(b) shows a schematic illustration of the internal configuration of a terahertz sensor;

FIG. 11(c) shows a schematic illustration of a lens for the terahertz sensor of FIG. 11(b);

FIG. 11(d) shows a schematic illustration of a lens and a mirror for the terahertz sensor of FIG. 11(b);

FIG. 12 shows a schematic illustration of an analysis unit;

FIG. 13 shows the terahertz measurement of cathodes;

FIG. 14(a) shows a plot of the variation of refractive index with bulk density;

FIG. 14(b) shows a Terahertz measurement of anode coatings;

FIG. 15 shows a schematic illustration of a method S1500 of manufacturing an electrode according to an embodiment;

FIG. 16(a) shows a schematic illustration of a sensor with a retro-reflector;

FIG. 16(b) shows a schematic illustration of a sensor with a retro-reflector;

FIG. 17 shows a plot of signals used for analysis;

FIG. 18 shows a plot of the measured thickness using a terahertz system; and

FIG. 19 shows a plot of the measured refractive index using a terahertz system.

### DETAILED DESCRIPTION

According to a first aspect, there is provided a method for analysing a sample comprising a layer having a first interface and a second interface, the method comprising:
Irradiating the sample with a pulse of terahertz radiation, said pulse comprising a plurality of frequencies in the range from 0.01 THz to 10 THz;
Detecting radiation reflected from the sample to produce a sample waveform;
Obtaining a first reflection waveform from the sample waveform, the first reflection waveform corresponding to the reflection from the first interface;
Obtaining a second reflection waveform from the sample waveform, the second reflection waveform corresponding to the reflection from the second interface;
Comparing the first reflection waveform with the second reflection waveform to produce an estimate of a thickness and a complex refractive index of the layer;
Producing a synthesised signal using the estimate of the thickness and complex refractive index;
Varying at least one of the thickness and complex refractive index to reduce an error between the sample waveform and the synthesised signal; and
Outputting the thickness of the layer.

The sample comprises a layer having a first interface and a second interface. The layer may be provided on a substrate. The first interface refers to the interface between an outer surface of the layer and an external environment. For example, the external environment is air. The second interface is the interface between the substrate and the layer.

In the method, an estimate of the complex refractive index and thickness of the layer is obtained. The estimate is obtained by irradiating the sample with a pulse of terahertz radiation, and detecting the reflected radiation. The estimate is used as a starting point in an iterative procedure which produces a complex refractive index and thickness of the layer.

The thickness of the layer is outputted.

The complex refractive index may also be outputted.

The method enables information relating to reflection from the layer to be obtained, by way of the first reflection waveform, and information relating to transmission through the layer to be obtained, by way of the second reflection waveform. This information is obtained using one measurement. The thickness and a complex refractive index can be estimated from said information. Using the estimates, a synthesised signal is obtained. The synthesised signal is compared to a sample waveform, and an error is determined. At least one of the thickness and complex refractive index is varied, such that the error is reduced. The method provides an estimate with improved accuracy. The estimate acts as a starting point for the variation of parameters to reduce the error. By having a more accurate starting point, the error may be reduced more effectively (e.g. more quickly and/or more accurately in terms of a final solution). A reduced error indicates that the parameters accurately describe the layer.

The varying of the parameters to reduce the error between the sample waveform and the synthesised signal may be referred to as an optimisation.

The error may be determined in the time domain. In the time domain, the synthesised signal is a time domain signal. Alternatively, the error may be determined in the frequency domain. In this case, the error may be frequency dependent (i.e. an error spectrum is obtained). To obtain the error spectrum, the sample waveform may be converted to the frequency domain to produce a sample spectrum, and the synthesised signal is a spectrum.

In an example, the error spectrum may weighted and one of thickness and complex refractive index is varied to reduce the weighted error spectrum. This enables the error to be reduce more effectively (e.g. more quickly)

For example, the parameters (thickness and complex refractive index) are varied until the error is minimised.

The initial estimate is obtained from the sample to be measured itself, without requiring a separate calibration sample.

In an example, the range over which the parameters are varied is determined in advance. The range may be determined by experimentation.

In an embodiment, the method comprises: Outputting at least one of a density and a conductivity of the layer,

Wherein the density and conductivity are determined from the thickness and/or complex refractive index.

From the determined thickness and/or complex refractive index, a thickness, a density and/or conductivity of the layer is determined and is outputted. The method enables one or more of the thickness, density and conductivity to be obtained using a non-contact, non-destructive manner using a single measurement. The method can also be used to extract two or all three of these quantities. The method is applicable to a production line environment for monitoring the manufacture of a layer.

In an embodiment, the method comprises obtaining a reference waveform, wherein the reference waveform is obtained by irradiating a reference sample with a pulse of terahertz radiation, said pulse comprising a plurality of frequencies in the range from 0.01 THz to 10 THz, and detecting radiation reflected from the reference sample to produce a reference waveform.

The reference sample may be a sample that has not yet been coated. The reference sample may be the substrate, prior to deposition of the layer. The reference sample may be an uncoated substrate. In an alternative example, the reference sample may be a plane mirror. The reference sample may be measured in advance so that the reference waveform is obtained in advance.

In an embodiment, obtaining the first reflection waveform and the second reflection waveform from the sample waveform comprises using time-gating. Time-gating is applied in the time domain. The purpose of time-gating is to select a segment from the sample waveform. Time-gating enables the reflection from the first interface and the reflection from the second interface to be analysed separately.

In an embodiment, the first reflection waveform is transformed to the frequency domain to obtain a first spectrum, and the second reflection waveform is transformed to the frequency domain to obtain a second spectrum. This allows the frequency dependence of the reflections to be analysed.

When a first spectrum and a second spectrum are obtained, comparing the first reflection waveform with the second reflection waveform to produce an estimate of a thickness and a complex refractive index of the layer comprises comparing the first spectrum with the second spectrum.

In an embodiment,
the sample waveform is deconvolved with the reference waveform to produce a deconvolved waveform;
the deconvolved waveform is time-gated to obtain the first reflection waveform and the second reflection waveform;
the first reflection waveform is transformed to the frequency domain to obtain a first spectrum;
the second reflection waveform is transformed to the frequency domain to obtain a second spectrum.

In an example deconvolving the sample waveform by the reference waveform comprises:
Transforming the reference waveform to the frequency domain to obtain a reference spectrum;
Transforming the sample waveform to the frequency domain to obtain a sample spectrum; and
Dividing the sample spectrum by the reference spectrum. A background waveform can be subtracted from the reference waveform and from the sample waveform before transforming the reference waveform and the sample waveform to the frequency domain, wherein the background waveform is obtained by taking a measurement with no sample in the path of the terahertz radiation.

An apodisation function can be applied to remove or supress edge effects in the sample waveform. For example, an apodisation function f(t) can be transformed into the frequency domain and multiplied by the sample spectrum. Removing or supressing the edge effects can improve the signal to noise ratio.

The purpose of time-gating the deconvolved waveform is to select the segment of the waveform that relates to the reflection from the second interface (second reflection waveform).

Deconvolution of the sample waveform with the reference waveform in the time domain is equivalent to dividing the sample spectrum by the reference spectrum.

In an embodiment, the method comprises determining an estimate of the thickness and the complex refractive index from the first spectrum and/or the second spectrum, wherein the complex refractive index is frequency dependent. This enables the frequency dependence of the thickness and complex refractive index to be captured. This enables a more accurate estimate of the thickness and complex refractive index to be obtained.

In an embodiment, the method comprises:
Transforming the reference waveform to the frequency domain to obtain a reference spectrum;
Determining an estimate of the real part of the complex refractive index from the reference spectrum and the first spectrum.

In an embodiment, the method comprises:
Obtaining the second reflection spectrum;
Correcting the second reflection spectrum;
Determining the imaginary part of the refractive index from the corrected second reflection spectrum; and
Determining the thickness from the corrected second reflection spectrum.

In an example, correcting the second reflection spectrum comprises:
correcting for the reflection from the first interface; and/or
correcting for the reflection from the second interface.

In an embodiment, the method comprises:
Fitting the estimate of the complex refractive index to a physical model to produce a model of the layer.

The complex refractive index is frequency dependent. The fitting enables the layer to be represented by model that is physically realistic. Having a physical model also reduces the number of parameters that have to be fitted to in the subsequent optimisation step. This enables the optimisation to be more effective (e.g. quicker and/or more accurate).

In an embodiment, the complex refractive index is varied to reduce an error between the sample waveform and the synthesised signal. This comprises varying parameters of the model, wherein the parameters of the model relate to the complex refractive index.

In an example, producing the estimate of a thickness and/or a complex refractive index of the layer comprises averaging. The thickness and complex reactive index depend on frequency. By taking an average, a single value for the estimate of the thickness in the time or frequency domain, and complex refractive index may be obtained. The average refers to the average over the frequencies. By using a single value of thickness and/or complex refractive index for the estimate, the fitting procedure may be simplified.

In an example, the method comprises:
Applying a filter to the first and/or second spectra;
Converting the filtered first and/or second spectra to the time domain to produce a filtered sample waveform; and
Varying at least one of the thickness and complex refractive index to reduce an error between the filtered sample waveform and the synthesised signal. The advantage is that noise in the sample waveform (which is the measured signal) is reduced and the error may be reduced more effectively.

In an embodiment, the method comprises determining a magnitude of the first reflection waveform;
Comparing a magnitude of the first reflection waveform with a magnitude of the reference waveform to produce a first ratio; and
Estimating a real part of the complex refractive index using the first ratio.

For example, the magnitude of the first reflection waveform is the magnitude of a peak arising from reflection from first interface. For example, the magnitude of the reference waveform is the magnitude of a peak arising from the reflection from the reference sample.

In an embodiment, the method comprises:
Determining a magnitude of the second reflection waveform;
Comparing the magnitude of the first reflection waveform with the magnitude of the second reflection waveform to produce a second ratio; and
Estimating an imaginary part of the complex refractive index using the second ratio.

For example, the magnitude of the second reflection waveform is the magnitude of a peak arising from reflection from the second interface.

In an embodiment, the method comprises:
comparing the first reflection waveform and the second reflection waveform to obtain a time delay; and
estimating the thickness using the time delay, or using the time delay combined with refractive index information.

According to a second aspect, there is provided a system for analysing a sample comprising a layer having a first interface and a second interface, the system comprising:
A sensor, the sensor comprising a pulsed source of terahertz radiation adapted to irradiate the sample with a pulse of terahertz radiation, said pulse a plurality of frequencies in the range from 0.01 THz to 10 THz, and a detector for detecting reflected radiation to produce a sample waveform, said sample waveform being derived from the reflected radiation; and
An analysis unit, said analysis unit comprising a processor and a memory, said processor adapted to:
obtain a first reflection waveform from the sample waveform, the first reflection waveform corresponding to the reflection from the first interface;
obtain a second reflection waveform from the sample waveform, the second reflection waveform corresponding to the reflection from the second interface;
compare the first reflection waveform with the second reflection waveform to produce an estimate of a thickness and a complex refractive index of the layer;
produce a synthesised signal using the estimate of the thickness and complex refractive index;
vary at least one of the thickness and complex refractive index to reduce an error between the sample waveform and the synthesised signal; and
output the thickness of the layer.

According to a third aspect, there is provided a system for analysing a sample comprising a layer having a first interface and a second interface, the system comprising:
A sensor, the sensor comprising a pulsed source of terahertz radiation adapted to irradiate the sample with a pulse of terahertz radiation, said pulse a plurality of frequencies in the range from 0.01 THz to 10 THz, and a detector for detecting reflected radiation to produce a sample waveform, said sample waveform being derived from the reflected radiation;
Wherein the sensor comprises an optical element adapted to resolve reflected radiation from both the first interface and the second interface.

In an embodiment, the optical element comprises a f-number of 3 or more.

In an embodiment the optical element comprises a f-number of 10 or more.

For example, the sensor of the second or third aspect further comprises:
a focussing element configured to direct the pulse of terahertz radiation towards the sample using a first path, and to direct the pulse of terahertz radiation towards an internal mirror using a second path; and
wherein the sample waveform comprises radiation reflected from the sample via the first path, and radiation reflected from the internal mirror via the second path.

According to a further aspect, there is provided a method for adapting a system for analysing a sample, the sample comprising a layer having a first interface and a second interface, the system comprising a sensor, the sensor comprising a pulsed source of terahertz radiation adapted to irradiate the sample with a pulse of terahertz radiation, said pulse a plurality of frequencies in the range from 0.01 THz to 10 THz, a detector for detecting reflected radiation, and an optical element, the method comprising:
Obtaining an estimate of the refractive index of the layer;
Obtaining an estimate of the thickness of the layer;
Determining a f-number of the optical element such that the confocal parameter, scaled by the estimate of the refractive index, is greater than the estimate of the thickness of the layer.

The confocal parameter is given by b=2z_{R}=π·w₀2/λ, where λ=λ₀/n, and w₀ is the beam waist.

The optical element is adapted to resolve reflected radiation from the first interface and the second interface.

According to a further example, there is provide a method for analysing a sample, the sample comprising a layer having a first interface and a second interface, the method comprising:
obtaining an estimate of the refractive index of the layer;
obtaining an estimate of the thickness of the layer;
determining an f-number of an optical element such that the confocal parameter, scaled by the estimate of the refractive index, is greater than the estimate of the thickness of the layer; and
performing a measurement using a system comprising a sensor, a detector and an optical element having an f-number greater than or equal to the determined f-number, wherein performing the measurement comprises:
irradiating the sample with a pulse of terahertz radiation, said pulse comprising a plurality of frequencies in the range from 0.01 THz to 10 THz, and
detecting reflected radiation.

According to a further aspect, there is provided a process for manufacturing an electrode for a battery, the process comprising:
coating a substrate with a layer;
drying the layer; and
calendaring the dried layer;
   the process further comprising:
analysing the layer using the methods herein, wherein the layer is analysed at any one or more of: before drying layer, after drying the layer, before calendaring the dried layer, and after calendaring the dried layer; and
adjusting process conditions for any one or more of the steps of: coating a substrate with a layer; drying the coated layer; and calendaring the dried layer.

According to another aspect, there is provided a sensor for analysing a sample comprising a layer having a first interface and a second interface, the sensor comprising:
a pulsed source of terahertz radiation adapted to generate a pulse of terahertz radiation, said pulse comprising a plurality of frequencies in the range from 0.01 THz to 10 THz;
a focussing element configured to direct the generated pulse of terahertz radiation towards a sample using a first path, and to direct the pulse of terahertz radiation towards an internal mirror using a second path; and,
a detector for detecting reflected radiation to produce a sample waveform, wherein the sample waveform comprises radiation reflected from the sample via the first path, and radiation reflected from the internal mirror via the second path.

The sample may comprise one or more layers.

The first path may be referred as the transmitted path; and the second path may be referred to as the reflected path.

In the sample waveform, the radiation reflected via the first path is separated temporally from the radiation reflected via the second path. This enables the reflected radiation from the internal mirror and the reflected radiation from the sample to obtained together (that is in the same measurement) while enabling the reflection from the internal mirror to be detected independently from the reflection from the sample.

The arrangement of the focussing element and the internal mirror sets the second path. In use, the arrangement of the focussing element and the sample sets the first path.

The first path and the second path each refer to an optical path length.

The optical path length is a geometric path length multiplied by the refractive index of the propagation medium.

The second path (reflected path) may be shorter than the first path (transmitted path) such that the radiation reflected from the internal mirror arrives at the detector before the radiation reflected from the sample. This enables the reflected radiation from the internal mirror to be detected independently from the reflected radiation from the sample.

In an example, the geometric transmitted (sample) path may be shorter but the transmitted optical path length to the sample may be longer due to the high refractive index of the silicon lens. The reflected path does not have such a difference because the path does not pass through the silicon lens.

In an example, the focussing element and the internal mirror are movable relative to one another such that the optical path length of the second path is adjustable. Adjusting the optical path length of the second path enables the adjustment of the temporal separation between reflected radiation from the first path and reflected radiation from the second path.

In an example, the focussing element comprises a front surface and a back surface,
wherein the front surface comprises a convex face, and the back surface comprises a planar face, and wherein,
in use, the front surface faces towards the sample and the back surface faces away from the sample,

In use, the front surface may nearer to the sample than the rear surface.

The purpose of the convex face of the front surface is to focus the beam. For example, the convex face defines the focal length of the lens.

The purpose of the planar surface of the back surface is to enable a beam to be reflected.

In an example, a normal vector of the back surface forms an angle with an optical axis defined by the front surface.

The angle is a non-zero angle.

The surface normal vector of the planar face of the focussing element is not aligned with the optical axis defined by the convex face and the beam path to the sample focus. The normal vector of the planar face is off-axis relative to the optical axis.

The purpose of the angle between the normal vector of the back surface and the optical axis is avoid obstructing incident and outgoing beams, The orientation of the planar face diverts the reflected beam away from the optical axis and away from the terahertz unit.

The focussing element enables a reference signal to be obtained from an internal mirror without introducing additional losses. The focussing element combines a beam splitting function with focussing into a single element.

In an example, the front surface of the focussing element is aspheric. The purpose of the aspheric configuration is to achieve an optimal focus.

In an example, the focussing element comprises silicon.

In an example, the silicon is high resistivity silicon.

In an example, the focussing element has an f-number such that the confocal parameter, scaled by the estimate of the refractive index, is greater than the estimate of the thickness of the layer.

In an example, the f-number is 3 or more.

The focussing element has a focal length. The sensor may also have an aperture. The aperture and the focal length set the f-number of the focussing element.

According to another aspect, there is provided a system for analysing a sample comprising a layer having a first interface and a second interface, the system comprising:
a sensor; and
an analysis unit.

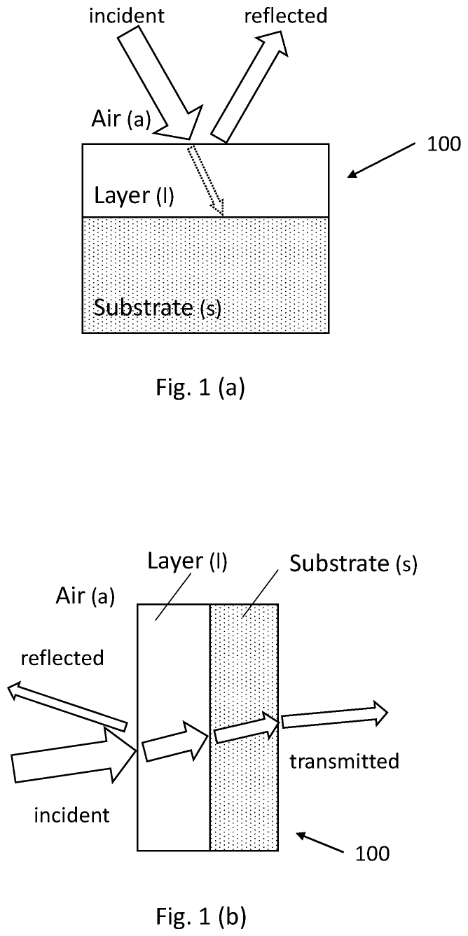

FIG. 1(a) shows a schematic illustration of analysing a sample 100 using a reflected beam. The sample 100 comprises layer (l) provided on a substrate(s). The sample 100 comprises a second interface between the substrate and the layer, and a first interface between the outer surface of the layer (l) and air (a). Although the first interface is described as being between the outer surface and air, it will be understood that, instead of air, a vacuum, or another gaseous environment could be used. For example the gaseous environment comprises nitrogen gas. Optionally, the sample is placed in a purge box to control the gaseous environment.

The sample is irradiated with terahertz radiation. At the first interface, a portion of the incident terahertz beam is reflected. The properties of the reflected depend on the properties of the layer (l). The reflected beam is detected and analysed. From the reflected beam, the refractive index, n, of the layer can be determined.

A portion of the incident beam may be transmitted beyond the first interface into layer (l). This is indicated by a dashed arrow in FIG. 1(a).

Another example of measuring samples using a reflected terahertz beam is provided in WO2018138523. In WO2018138523, calibration samples are required to obtain an estimate of parameters.

Another example of measuring samples using a reflected terahertz beam is provided in Krimi, S., Klier, J., Jonuscheit, J., von Freymann, G., Urbansky, R. and Beigang, R., 2016. Highly accurate thickness measurement of multi-layered automotive paints using terahertz technology. Applied Physics Letters, 109 (2), p.021105. Separate calibrations are made and the thicknesses of layers is estimated using these calibrations. Accurate values of the complex refractive index are not given, nor is density or conductivity determined

Another example of measuring samples using a reflected terahertz beam is provided in U.S. Pat. No. 10,076,261 B2. In U.S. Pat. No. 10,076,261 B2 abnormalities in a sample are detected along with images of layer thicknesses. Density, conductivity and real and imaginary parts of the refractive index are not determined.

WO2017051579A1 describes an example of measuring the thickness of a film using a reflected terahertz wave. WO2017051579A1 does not describe measurement of a complex refractive index. Density and conductivity information are not determined.

FIG. 1(b) shows a schematic illustration of analysing a sample 100 using a transmitted beam. The sample 100 is the same as for FIG. 1(a). The sample is irradiated with terahertz radiation. At the first interface, a portion of the incident terahertz beam is reflected, and another portion of the beam is transmitted through the layer (l) towards the second interface. At the second interface, the beam is transmitted through the substrate(s) and exits the sample. The beam that exits sample is referred to as the transmitted beam. The transmitted beam has travelled through air (a), layer (l), and the substrate. The properties of the transmitted beam depend on the properties of the layer (I) and the substrate(s). The transmitted beam is detected and analysed. From the transmitted beam, the combined effect of the layer (l) and substrate(s) may be determined. For example, the combined effect of the refractive indices and thicknesses of the layer (l) and substrate(s) may be derived.

To determine the refractive index or thickness of the layer (l) or substrate(s), further measurements must be performed. Further, when the substrate is lossy and/or thick, the transmitted beam is heavily attenuated.

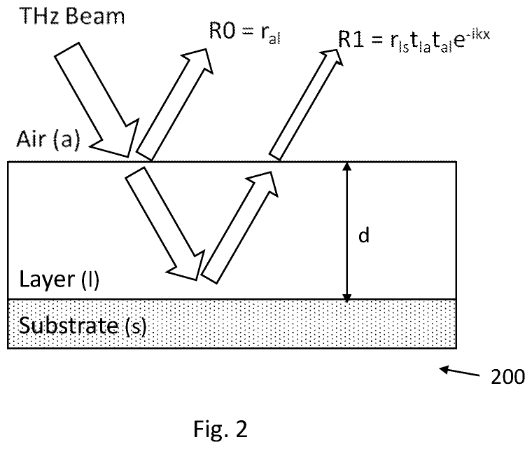

FIG. 2 shows a schematic illustration of analysing a sample 200 by irradiating the sample with terahertz radiation and measuring the reflection. The sample 200 comprises layer (l) having a first interface and a second interface. The layer (l) has a thickness d. The first interface is formed between an outer surface of the layer and air. The first interface is described as an air-layer interface is represented by subscript “al”. As described in relation to FIG. 1(a), instead of air, vacuum or another gaseous environment may be present.

The second interface is formed between another surface of the layer (l) and the substrate(s). The second interface is opposite the first interface. The second interface is referred to as the layer-substrate interface and is represented by subscript “Is”.

The sample 200 is irradiated with terahertz radiation (THz Beam). At the first interface, a portion of the incident terahertz beam R0 is reflected. The reflected beam R0 is also represented by rₐₗ. rₐₗ may be referred to as a reflection coefficient. rₐₗ represents what fraction of the incident beam is reflected. The reflected beam R0 is referred to as the first reflection.

The properties of R0 depend on the layer (l). In particular, R0 depends on the refractive index n of layer (l).

Another portion of the THz beam is transmitted from the first interface towards the second interface. The fraction of the THz beam that is transmitted is represented by a transmission coefficient tₐₗ.

At the second interface, a portion (fraction) of the beam is reflected. The fraction of the beam that is reflected at the layer-substrate interface (second interface) is represented by a reflection coefficient rₗₛ. Said reflected beam travels through the layer (l) of thickness d until it reaches the layer-air interface. The layer air-interface corresponds to the first interface (air-layer interface). The transmission and/or reflection of the beam at the first interface depends on whether the beam is travelling from air to the layer, or from the layer to air.

At the first interface, a fraction of the beam is transmitted out of the sample. The fraction that is transmitted is represented by a transmission coefficient tₗₐ. Said beam is represented by R1. R1 is referred to as the second reflection.

The properties of R1 depend on the properties of the layer (l). In particular, R1 depends on the refractive index of layer (l) and its thickness d. The real part of R1 may be represented by: R1=rₗₛtₗₐtₐₗ exp(−iκ·ω·x/c), where i=√−1, κ is the imaginary part of the refractive index, ω is angular frequency, x represents the distance travelled by the beam in layer (l), and c is the speed of light in vacuum. The imaginary part of the refractive index, κ, is related to the absorption coefficient.

The magnitude of the R1 reflection is dependent on the transmission through the air-layer interface, the reflection of the layer-substrate interface and the absorption in the layer.

Optionally, this may be simplified as the transmission through the air-layer interface is (1+rₐₗ) i.e. 1+R0. As will be described below, R0 is measured, and transmission through the air-layer interface (tₐₗ=1+rₐₗ) may be derived, thus allowing dependence on tₐₗ to be removed.

Similarly, the transmission at the layer-air interface, tₗₐ, may be derived from the measured R0 (=rₐₗ), thus allowing the dependence on ta to be removed.

Optionally, the air-substrate reflection (rₐₛ) may be assumed to be fixed. For example, the substrate may be assumed to be a metallic substrate. Alternatively, the air-substrate reflection (rₐₛ) may be obtained by measurement on an uncoated substrate(s). The air-substrate reflection (rₐₛ) may then be corrected to obtain a layer-substrate reflection (rₗₛ).

By making the above simplifications, the magnitude of the second peak R1 is dependent on the absorption in the layer. Therefore measurement of magnitude of R0, delay between R0 and R1 and magnitude of R1 allows an estimate to be made of the optical properties of the layer and the layer thickness.

The reflection coefficient rₐₗ, the transmission coefficient tₐₗ, and the transmission coefficient tₗₐ depend on the refractive indices of air and layer (l). The reflection coefficient rₗₛ depends on the refractive indices of that layer (l) and the substrate(s).

The terahertz beam incident on the sample encounters the first interface, travels though the layer (l), and then encounters the second interface.

The first reflection R0 and the second reflection R1 are separated in time. R0 and R1 undergo different optical delays. R0 and R1 can be measured using terahertz time domain spectroscopy.

The optical delay between the R0 reflection and R1 reflections is proportional to the refractive index and the sample thickness (˜nd).

The R0 and R1 reflections can be separated in time using terahertz time domain spectroscopy. R0 and R1 reflections may be obtained with a single measurement.

In the arrangement of FIG. 2, with a single measurement, reflections R0 and R1 may be obtained. Measurement of R0 and R1 simultaneously provides the information contained in the reflection measurement shown in FIG. 1(a), and the information contained in the transmission measurement shown in FIG. 1(b). From one measurement, the thickness and the complex refractive index of the layer may be obtained.

The measurements are also non-contact measurements. SUCh measurements may be performed in a production facility for monitoring the properties of layers during a manufacturing process.

From the thickness and the complex refractive index of the layer, other properties such as the conductivity or density may be derived. Conventionally, optical properties of a layer (e.g. thickness) would be measured using laser interferometry, conductivity would be measured using four point probe measurements, and density would be measured using ultrasound measurements or by weighing samples and measuring coating independently. These methods have their limitations, requiring calibrations and multiple measurements (e.g. weight and thickness separately to determine density) which can multiply errors. Some of these measurement techniques (e.g. beta measurements for weight) are also slow and not compatible with high speed production lines.

Embodiments described herein enable one or more of these properties to be determined by way of one measurement.

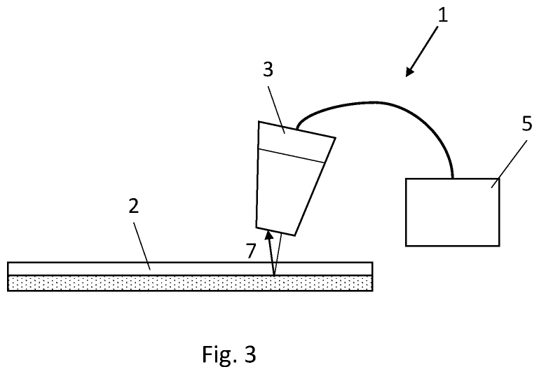

FIG. 3 shows a schematic illustration of system 1 for analysing a sample 2. The system comprises a sensor 3 and an analysis unit 5. The sensor 3 is connected to the analysis unit 5. The sensor comprises an emitter and a detector and is configured to emit and detect terahertz radiation. An example of a sensor is described in WO2018138523, which is incorporated herein by reference. Another example of a sensor is provided in U.S. Pat. No. 10,076,261 B2, which is incorporated herein by reference.

The analysis unit 5 is configured to process the information collected by the sensor 3. The analysis unit 5 is described further below. The analysis unit may be adapted to implement any of the methods described herein.

The sensor 3 is configured to emit a broadband pulse of terahertz radiation 7 towards a sample 2. The terahertz radiation pulse will comprise a plurality of frequencies. For instance, the radiation will be in the range of 0.01 THz to 10 THz. However, in some embodiments, the range will be narrower, such as in the range from 0.06 THz to 4 THz, or possibly lower in frequency range, depending upon the transmission/absorption properties of the coating under study.

The sensor 3 is further configured to detect terahertz radiation 7 that is reflected from the sample.

The system 1 may implement any of the methods described herein.

Optionally, the sample 2 may correspond to sample 200 described in relation to FIG. 2.

Additionally or alternatively, sample 2 may correspond to a coating on an electrode for a battery. For example, the sample 2 may correspond to the coating on the anode or cathode of a battery. The sample 2 comprises a layer on a metallic substrate. The metallic substrate may be copper or aluminium, for example. The metallic substrate is coated with a layer of material. The coating comprises a mixture of components. For example, for an anode for a lithium-ion battery, the coating comprises an active material, a conductive additive, and a binder, for example. The coating may be porous.

At least one of the thickness, electrical conductivity (referred to as conductivity), or density of the coating may be monitored by way of system 1.

As will be described herein, the complex refractive index and the thickness of the coating is derivable from the reflected terahertz beam.

From the complex refractive index, the conductivity of the coating may be derived.

The relationship between optical constants and conductivity may also be approximated as follows.

Refractive index is related to dielectric constant by:

$$n = √ ϵ = n + i κ ,$$

Where ñ is the complex refractive index, ϵ is the dielectric constant, n is real part of refractive index and κ is the imaginary part.

Then the dielectric constant can be related to conductivity via:

$$ϵ = {ϵ}_{L} + 4 π i σ ( ω ) / ω$$

Where ω is the angular frequency, ϵ_{L} is dielectric constant due to a lattice and σ(ω) is the frequency dependent conductivity given by:

$$σ ( ω ) = {σ}_{0} / ( 1 - i ω τ )$$

Substituting the free electron frequency dependent conductivity into the above equation:

$$ϵ = {ϵ}_{L} + 4 π i {σ}_{0} / ω / ( 1 - i ω τ )$$

Note that the models used to fit to n and k are models for ϵ, which is Drude model for free carriers. This may be used to fit n and k. Therefore the model for conductivity is built into the model for refractive index. The choice of model will be material dependent (depends on what approximations are made to simplify the model).

For example, the imaginary part of the index of refraction k of a material in the Terahertz is related to its high frequency conductivity σ using the equation σ(ω)=2·n·κϵ₀ω.

From the real part of the refractive index, the density can be determined. The density of a bulk material is proportional to the Terahertz refractive index (see Journal of Pharmaceutical Sciences On-line DOI 10.1002/jps.23560 (2013)) and hence a correlation between the two can be used to determine density from the measured real part of the refractive index.

From the porosity, a density (ρ) of the coating may be determined.

The density ρ may be related to refractive index n by effective medium theory. From, effective medium theory given a medium with refractive index n and given the medium is 5% porous then the effective refractive index is a sum of the two ratioed by their volume. i.e. 0.95*n+0.05*n₀. Here, n0 represents the density of air in the porous material. n0=1, for example. The relationship assumes that the vacancies (pores) are much smaller than the wavelength of the terahertz radiation.

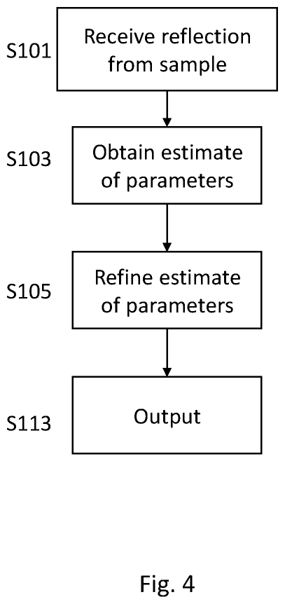

FIG. 4 shows a schematic illustration of a method for analysing a sample, according to an embodiment. The sample comprises a layer that has first interface and a second interface. Optionally, the sample corresponds to sample 200 shown in FIG. 2. The method of FIG. 4 is implemented by the system 1 of FIG. 3.

In step S101, a reflection from the sample is obtained. The reflection may be obtained by way of the system 1 shown in FIG. 3, for example.

In step S103, an initial estimate of the parameters of the layer is obtained. The parameters may be the thickness and/or the complex refractive index of the layer, for example. The real part of the complex refractive index, n, may be referred to as the refractive index. The imaginary part of the complex refractive index, K, may be referred to as the absorption coefficient. How the initial estimate is obtained is described further below.

In step S105, the initial estimate is refined to produce a more accurate value of the thickness and/or the complex refractive index of the layer. How the value of the parameters is refined will be described further below. Briefly, a synthesised signal is produced using the initial estimate, the synthesised signal is compared to the received reflection and one or more parameters are adjusted to reduce the difference between the synthesised signal and the received reflection.

Step S105 may be referred to as an optimisation.

In step 113, an output is produced from the parameters (thickness and/or the complex refractive index of the layer). The output comprises at least one of the thickness, conductivity, or density of the layer.

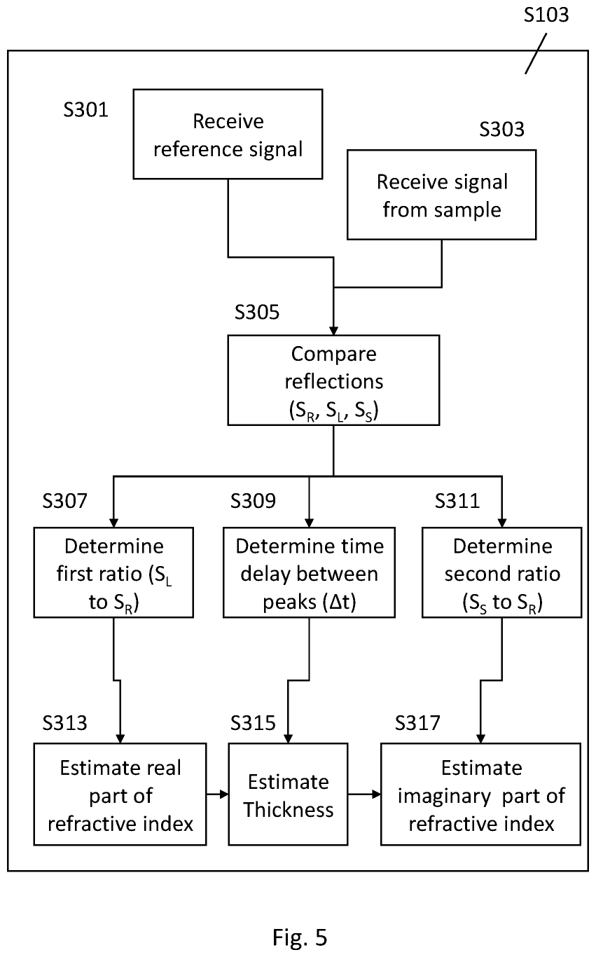

FIG. 5 shows a schematic illustration of obtaining an initial estimate of the thickness and/or complex refractive index of the layer. FIG. 5 shows step S103 of FIG. 4 in more detail. The method of FIG. 5 may be understood as a method of obtaining the initial estimate of thickness and/or complex refractive index of the layer in the time domain.

In step S301, a reference signal is received. The reference signal represents the reflection from a reference sample. The reference signal may be a waveform (such as the reference waveform) or it may be a value (reference value). For example, the reference sample comprises an uncoated sample. The uncoated sample is similar to the sample 200 in FIG. 2 except that the layer (l) is not present. In other words, the uncoated sample corresponds to the substrate. The reference sample may be the sample prior to coating with layer (l), for example. The reference signal relates to the terahertz radiation reflected by the reference sample when it is irradiated with an incident terahertz beam. The reference signal comprises a reflected waveform which shows an intensity of the reflection beam as a function of time delay. When the terahertz beam is incident on the uncoated substrate, the reflected beam relates to the properties of the substrate(s). The substrate may be a metallic substrate, which is reflective. The reflected beam describes the reflectivity of the substrate.

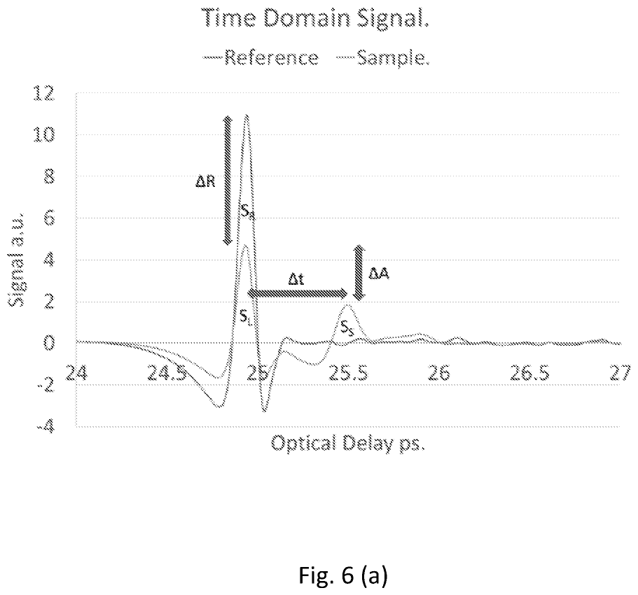

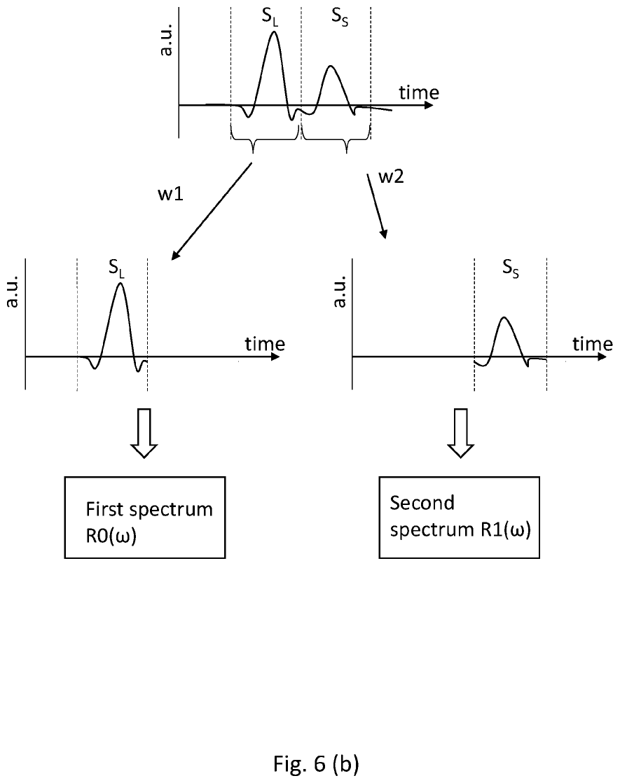

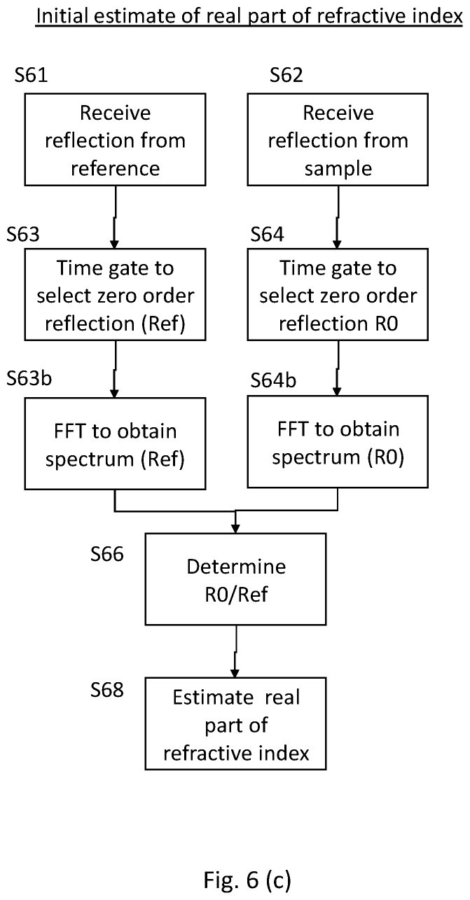

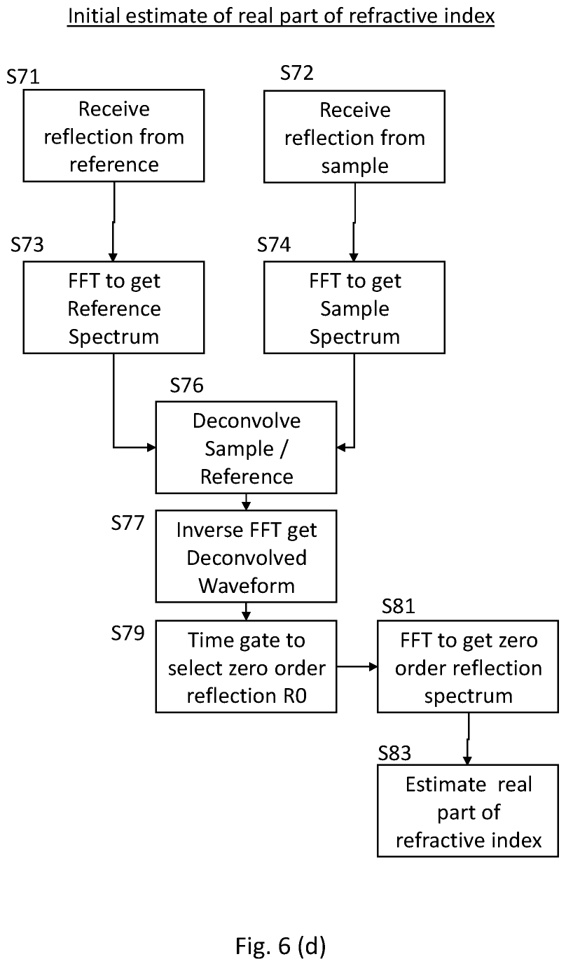

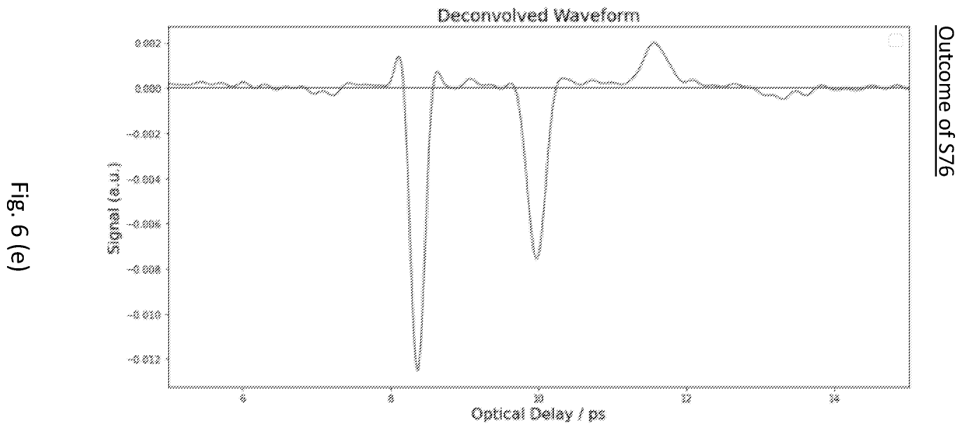

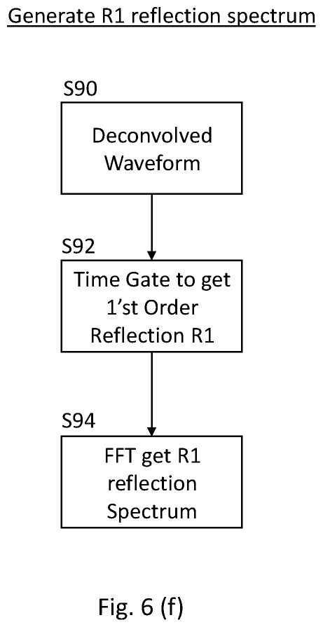

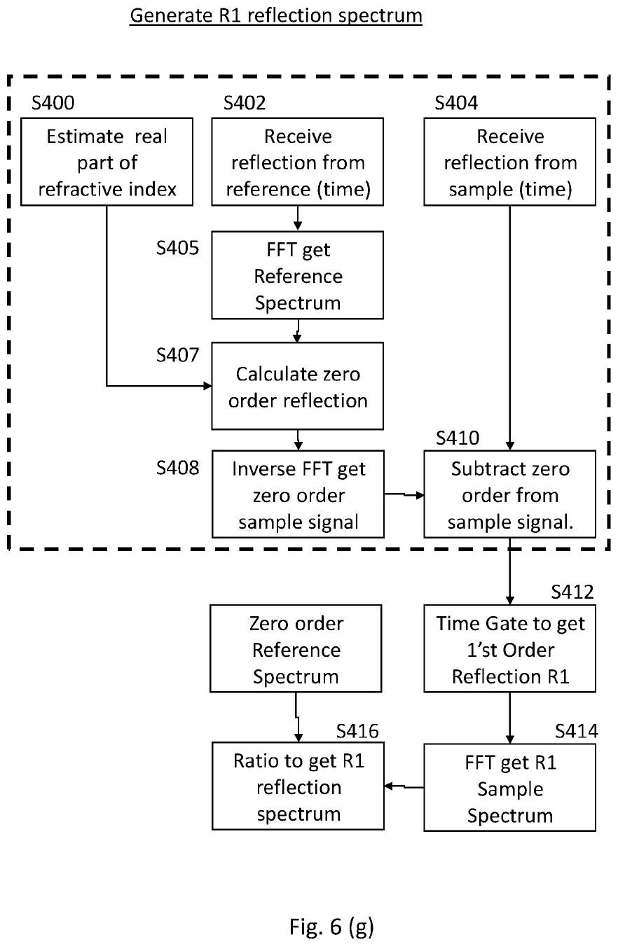

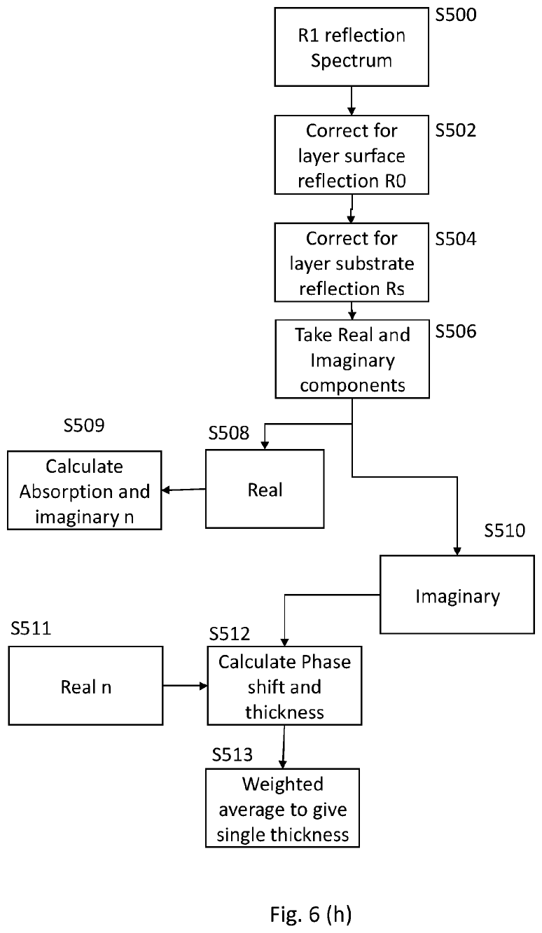

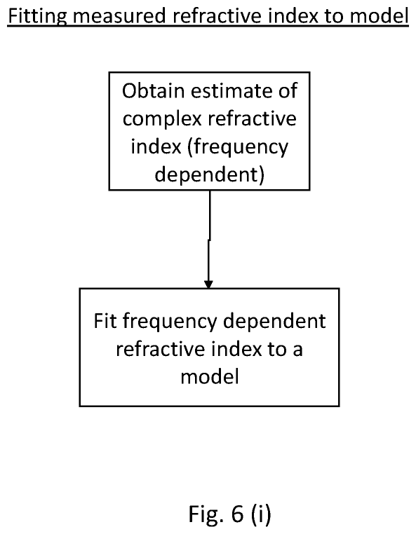

In an example, from the reference waveform, a reference value is derived. For example, the reference value may be the magnitude of the peak arising from reflection from the substrate. The reference value may correspond to the peak S_{R} described in relation to FIG. 6(a).

In step S303, a signal from the sample is received. The signal from the sample relates to the terahertz radiation reflected by the sample when it is irradiated with an incident terahertz beam. The reflected signal comprises a reflected waveform which shows an intensity of the reflection beam as a function of time delay. The received signal is used to produce a sample waveform. The sample waveform is described further herein.

In step S305 the sample waveform is compared to the reference value.

FIG. 6(a) shows a plot of the signals obtained from a reference sample and the sample comprising a layer. The sample with the layer corresponds to the sample 200.

The vertical axis represents the signal magnitude in arbitrary units. The horizontal axis shows the optical delay in picoseconds (ps). The signal from the reference sample is shown in blue (dashed lines) while the signal from the sample comprising the layer is shown in orange (solid lines). The signal from the reference sample has a single peak (S_{R}) arising from reflection from the substrate. The signal from the sample with the layer comprises two peaks. The first peak S_{L} corresponds to the reflection from the surface of the layer (l). The second peak S_{S} corresponds to the reflection from the substrate(s).

In FIG. 6(a), the difference in the reflectivity from the layer surface S_{L} (first peak) and the reflection from the reference sample S_{R} is indicated by ΔR. The time delay between the reflection from the layer surface (S_{L}) and the reflection from the substrate (S_{S}) is indicated by Δt. The difference in the reflectivity from the layer surface S_{L} (first peak) and the reflection from the substrate surface S_{S} (second peak) is indicated by ΔA.

Returning to FIG. 5, in step S307, ΔR is determined. ΔR is obtained by comparing the magnitudes of S_{L} to S_{R}. For example, the peaks may be identified, and their magnitudes determined. ΔR provides an approximation of the real part of the layer refractive index. ΔR is related to the ratio of S_{L} to S_{R} as Su/S_{R}=1−ΔR/S_{R}. The ratio of S_{L} to S_{R} may be represented by ‘r’ (S_{L}/S_{R}=r) for ease. The relationship between r and n comes from Fresnel equations. For example, for an air (with refractive index of 1) to material (with refractive index of n) interface the reflection r is given by r=(1−n)/(1+n). This can be rearranged to give n=(1−r)/(1+r). The reflection r is measured and n may then be calculated from r. The expression is for normal incidence but it may be adapted for non-normal incidence.

In S313, an estimate of the real part of the refractive index is obtained, from the ratio of S_{L} and S_{R}. The ratio of S_{L} and S_{R} is also referred to as the first ratio. S_{R} corresponds to the reference value of step S305.

In step S309, the time delay Δt between the first and second peaks is obtained. The time delay between the reflection from the layer surface (S_{L}) and the reflection from the substrate (S_{S}) i.e. (Δt) is a measure of the time taken to propagate through the layer (twice). This time is proportional to the layer thickness, the speed of light and the refractive index. Since the speed of light is known and an approximation for the refractive index is known from S313, an initial estimate of the layer thickness may be obtained in step S315.

The layer thickness may be estimated as:

$$d \sim Δ t / n$$

The layer thickness may be found from d=c Δt/(2n), where c is speed of light, and the factor of 2 comes from the fact that the beam goes through the layer twice.

In step S311, a second ratio is obtained by comparing the magnitudes of S_{S} to S_{L}. As shown in FIG. 6(a), the peaks at S_{S} and S_{L} may differ by an amount ΔA. ΔA is obtained by comparing the magnitude of the S_{L} and S_{S}. Since S_{L} is related to S_{R} from the first ratio, the second ratio may alternatively be obtained by comparing the magnitudes of S_{S} to S_{R}.

In S317, from the second ratio and the estimate of the layer thickness from S315, an estimate for the absorption of the layer (l) may be determined. The absorption of the layer (l) corresponds to the imaginary part of the refractive index, K.

The propagation through a layer of thickness d is given by exp(−i·ñ·ω·d/c) this can be split into real and imaginary parts. The imaginary part (real n due to the factor of i) gives phase shift (time delay). Real part (imaginary n) gives exponential decay of the form exp(ω·κ·d/c). Therefore, from the ratio of the reflections In(|S_{S}/S_{L}|)=ω·κ·d/c and can be rearranged to give K (imaginary part of refractive index).

Referring to the plots shown in FIG. 6(a), the plots correspond to a reflection waveform from the sample (sample waveform), and a reflection waveform from a reference sample (reference waveform). The reflection waveforms are raw signals. The sample waveform comprises the contribution of the instrument as well as the contribution of the sample. The reference waveform comprises the contribution of the instrument as well as the contribution of the reference sample.

The contribution of the instrument may be referred to as the instrument response. The instrument response is a measurement of the contribution of sensor components used to measure the reflected beam. Optionally, the instrument response is removed from sample waveform. A sample waveform where the instrument response has been removed may be referred to as a sample response. The sample response may be obtained in a number of ways. For example, the sample response is derived from a reflected waveform by deconvolving the reflected waveform with the reference waveform. Alternatively, the sample response may be derived by subtracting the reference waveform from the sample waveform.

The instrument response may be derived from a mirror. A mirror gives a reflection of ˜ 1. The reference waveform is determined by detecting a THz beam reflected from a mirror. The mirror may be a plane mirror. The mirror may be a gold mirror for example. The plane mirror is provided at the focus of the sensor 3 such that the terahertz beam is reflected back to the sensor. The terahertz beam reflected from the reference surface and detected by the system 1. The reflected beam describes the instrument response. Determining the instrument response is further described in WO2018138523.

The response from the mirror can be used in two ways. Firstly, when the substrate(s) is known to be reflective, the reflectivity of the substrate may be taken to be the same as the reflectivity of the mirror. Then the reference waveform of the substrate is assumed to correspond to that of the mirror. Secondly, an uncoated substrate(s) is measured. The uncoated substrate is similar to the sample 200 of FIG. 2 except that no layer (l) is provided. The reflection from the uncoated substrate is measured, compared to the reflection from the mirror, and a reflectivity for the substrate may be derived.

Alternatively, instead of a plane mirror, the uncoated substrate is used to derive an instrument response. The uncoated substrate may comprise a metallic substrate (which is reflective). When the terahertz beam is incident on the uncoated substrate, the reflected beam relates to the properties of the substrate(s), including its reflectivity. The reflected beam also describes the instrument response. From said reflected beam, the reference waveform may be derived. The response of a mirror may also be measured. The reference waveform may be further multiplied by (mirror)/(substrate) to turn the substrate measurement into a mirror measurement. The reference waveform may correspond to the reference signal referred to in steps S301 and S305 of FIG. 5.

When the substrate is highly reflective, the uncoated substrate may be used to obtain the instrument response, and the use of a further mirror is avoided.

Additionally and optionally, the reflectivity of the substrate(s) is obtained prior to measuring the sample. The reflectivity may be measured on the substrate prior to deposition of the layer. Alternatively, when the substrate has a consistent reflectivity value, said value may be measured once and stored for use. Yet alternatively, a value for the reflectivity may be assumed. The reflectivity of the substrate relates to the received reference signal described in relation to step S301 and FIG. 5. The reflectivity of the substrate is also related to the coefficient is described in relation to FIG. 2.

Note that there is a useful check for the substrate reflectivity as the reflection from the full structure will tend to the reflection of the substrate at low frequency.

FIG. 6(a) illustrates the reflection waveforms of the THz beam in the time domain. The time domain representation illustrates that the different reflections from the sample arrive at the detector at different times. The time domain representation also illustrates the difference in the peaks (S_{R}, S_{S}, S_{L}) of the reflected signals.

As described in relation to FIG. 5, the Δt and S_{R}, S_{S}, and S_{L} may be obtained from the plots shown in FIG. 6(a) and used to determine the thickness and/or complex refractive index of the layer.

The method of FIG. 5 comprises analysing waveforms shown in FIG. 6(a) in the time-domain to obtain an estimate. The method of FIG. 5 is based on determining peak heights and the temporal separation between the peaks. The advantage of this method is that it is simpler (less processing is required) and quicker. SUCh a method is useful for industrial monitoring applications.

Optionally, the accuracy of the method of FIG. 5 is improved by filtering. For dispersive materials, the peak shape may change and the peak separation/heights may no longer be separable. The method of FIG. 5 may optionally comprise a frequency filtering step for selecting a small range of frequencies. This may reduce the effect of dispersive materials and improve the accuracy of the approximation. The steps of filtering comprise:
1) Obtaining sample waveform and a reference waveform;
2) Transforming the sample waveform and reference waveforms to the frequency domain (e.g. using a FFT) to produce a sample spectrum and a reference spectrum
3) Obtaining the ratio sample/reference—to deconvolve.
4) Multiplying by a frequency selection filter (an example of a filter is a bandpass)
5) Taking an inverse transform, to obtain a filtered waveform
6) Analysing the peaks of the filtered waveform.

For example, analysing the peaks of the filtered waveform comprises performing steps S313, S309, S315 and S317 of FIG. 5.

Note that while this peak analysis method does not give a direct measure of conductivity, it does provide a measure of the complex refractive index at a single frequency. The measure of the complex refractive index can be calibrated to provide a conductivity.

The determination of the thickness and/or complex refractive index in the frequency domain is described below, in relation to FIG. 6(b) to FIG. 6(i). The frequency dependence of the complex refractive index may be captured in the initial estimate by considering the frequency response of the reflected waveforms.

FIG. 6(b) shows a schematic illustration of time gating a time domain signal. FIG. 6(b) also illustrates the conversion of the time-gated time domain signal to the frequency domain.

### Time Gating

Time-gating will be described with reference to the reflection waveform of the sample (solid line) shown in FIG. 6(b). With time gating, a first window w1 is applied to the waveform to select the first reflection S_{L} only. A second window w2 is applied to the waveform to select the second reflection S_{S} only.

The purpose of time-gating is to select segments of a waveform in the time domain. In other words, time-gating may be used to isolate segments of the waveform.

In a non-limiting example, the first and/or second windows may be a boxcar function.

A window may be defined by identifying the peak, and then selecting an appropriate window width.

A non limiting example for defining a window is the following:
1) find time of R0 peak, t0
2) find time of R1 peak, t1
3) predefine peak width, w
4) window width is then given by t1-t0-w
5) R0 window is centered on R0 peak.
6) R1 window is centered on R1 peak.

The window regions may overlap. However, the window function is weighted towards the centre of the window. In this example, both windows have the same width. However, different widths may be used.

Alternatively, instead of the boxcar function, other window functions may be used.

Time gating produces a first reflection waveform, indicated by w1 in FIG. 6(b), that describe the first reflection S_{L} and a separate second reflection waveform, indicated by w2 in FIG. 6(b), that describes the second reflection S_{S}.

### Frequency Domain

As shown in FIG. 6(b), the time gated reflection waveforms w1 and w2 are separately converted to the frequency domain. However, the conversion to frequency domain is optional. For example, to convert the time gated waveforms to the frequency domain, a fast Fourier transform (FFT) is performed on each of the first and second reflection waveforms. Two frequency-domain reflection spectra are obtained. A first spectrum describes the first reflection S_{L} in the frequency domain. The second spectrum describes the second reflection S_{S} in the frequency domain. The first and second spectra contain magnitude and phase as a function of frequency, for the first reflection S_{L} and second reflection S_{S} respectively.

The first spectrum may be referred to as R0. The second spectrum may be referred to as R1. R0 and R1 are frequency dependent.

In an alternative that is not shown, time gating is performed as follows:
obtain a time domain waveform
convert to frequency domain
process in frequency domain. Processing may include any one or more of, filtering, deconvolving, or correcting.
convert to time domain
applying a window for time gating as described above.

The first and second spectrum may then be used to derive the initial estimate of the complex refractive index and/or thickness. The derivation is similar to that described in relation to FIG. 5, except that the ratios and hence complex refractive index is frequency dependent.

An explanation of how the initial estimate of the complex refractive index and thickness is obtained, by converting the time domain waveforms into spectra, is provided next. The processing in the frequency domain are related to the ratios presented in relation to FIG. 5 (which relates to processing in the time domain) for ease of understanding. Further below, how the initial estimate of the complex refractive index and thickness is obtained will be described in more detail below in relation to the diagrams of FIGS. 6(c) to 6(i).

To estimate the first ratio, the magnitude of the first spectrum is taken and compared to the received reference signal. The relationship between the refractive index and the ratio is obtained as r(ω)=(1−n(ω))/(1+n(ω)).

When comparing the first spectrum to the reference, the reference waveform is transformed to produce a reference spectrum. r(ω) corresponds to first spectrum/reference spectrum.

The ratio of sample spectrum/reference spectrum is independent of the instrument and only contains information about the sample.

To estimate the time delay, a phase difference between the two spectra is obtained. The phase shift is obtained by subtracting the phase of the reference spectrum from the second spectrum. The ratio R1/Reference in the frequency domain (i.e. ratio spectrum) performs a phase subtraction (property of complex numbers). Therefore the phase in the ratio spectrum provides the delay. The delay can then be related to the imaginary part of the exponential term exp(−i·n·ω·d/c). Due to the factor of i, this is the real part of the refractive index, i.e. phase shift=−n·ω·d/c allowing d to be calculated (since n is known).

To estimate the second ratio, the magnitude of the reference spectrum (Ref) is taken and compared to the magnitude of the second spectrum (R1). Reference is made to FIG. 2. R1/Ref is given by t₁₂×t₂₁×rₗₛexp( ) where t₁₂ and t₂₁ are the transmission through the interface-which are equal to (1-r0) and −(1-r0) respectively. The subscript 1 refers to air and the subscript 2 refers to the layer (l). Since R0 has been measured, these can be corrected for. The substrate reflection is calculated by pre-measurement or a known value is assumed. Once these terms are removed it is only the real part of the exponential (decay) that is related to k. The relationship may be expressed as R1/Ref=t₁₂×t₂₁×rₗₛ×exp(ω·κ·d/c).

The estimated parameters n, d, and κ are frequency dependent.

While the estimated d is frequency dependent, a weighted average of the value of the frequency dependent d may be taken and used as the estimate for d. For example, d(ω) may be averaged over values of ω where the measured data is of high quality (e.g. low noise).

By capturing the frequency dependence of n, d, and κ, a more accurate initial estimate may be obtained.

The initial frequency dependent estimate for complex refractive index (ñ=n+i·κ) is fitted to a model before any fitting is done to the waveform. For example, n(ω) and κ(ω), may be fitted to a Drude or Drude-Lorentz model. The model is then used in the subsequent optimisation step. The advantage of fitting to a model is that a physically realistic description of the reflection waveform is used in the subsequent optimisation step. A further advantage is that the number of parameters in the subsequent optimisation step is reduced. For example, for x frequency points, there would be 2× parameters to fit to (for real and imaginary parts of refractive index). By using a fitted model in the optimisation step, only the parameters of the model are varied (rather than having to vary the value of refractive index at each frequency point).

Further, optionally, the frequency dependence of n, d, and κ may indicate what type of model to use in the subsequent refinement step. For example, from the frequency dependent estimate for complex refractive index (ñ=n+i·κ), a model that more accurately represents the physical behaviour of the layer may be selected. The selected model may then be used in the optimisation step.

Additionally and optionally, the first spectrum and/or the second spectrum are filtered prior to any derivation of parameters therefrom. For example, a filter (e.g. low-pass, or band pass) may be applied to the first and/or second spectra to reduce noise. The filtered spectra may then be converted back to the time domain using an inverse FFT. The noise in the time domain signal may be reduced. The filtered time domain signal (or filtered spectrum) is then used in the initial estimation of parameters.

Additionally and optionally, a filter may be applied to emphasise frequencies that are most sensitive to a measured parameter while attenuating other frequencies. An example of such a filter is a bandpass filter. The filtered spectra are converted back to the time domain. The time domain band passed signals are then used in step S105. Parameters may be derived with greater accuracy.

In step S105, at the fitting/optimisation stage, the whole waveform is used. The purpose of separating the waveform into R0 and R1 is to enable analytically solving for the initial estimates. In step S105, the sample spectrum/reference spectrum is considered. The expected reflection is modelled, while floating the fitted refractive index parameters and thickness. This is optimised when (synthesised signal—sample waveform) minimised. Optimisation can be done in frequency space or time domain.

When fitting in the frequency space, the error between the synthesised spectrum (the synthesised spectrum refers to the frequency domain form of the synthesised signal) and the sample spectrum (transform of sample waveform to frequency domain) is reduced. The spectra may be optimised as it saves processing time.

Additionally and optionally, when fitting in the frequency space, multiple fits with different frequency ranges may allow improved parameter optimisation. When fitting in spectra, the error function is (synthesised spectrum—sample spectrum) and is a function of frequency. This error function may be weighted to define which part of the spectrum is of most importance. For example, parts of the spectrum where the signal is noisy and could be given a low weighting.

Further additionally, in a non-limiting example, assuming part of the spectrum is sensitive to thickness but insensitive to other parameters, then an initial fit could be made with just this part of the spectrum and varying the thickness while keeping the other parameters fixed. In other words, the error spectrum is weighted and at least one of thickness and complex refractive index is varied to reduce the weighted error spectrum. The advantage is that the error may be reduced more effectively (e.g. faster and more accurately).

Note that part of the time domain signal may be selected by time gating to remove the effect of additional reflections that are not to be included in the model.

FIGS. 6(c) to 6(i) are described below. These figures also relate to obtaining initial estimate of the complex refractive index and thickness. The figures illustrate how the methods may be implemented. The description above in relation to processing the reflection in the frequency domain also applies to FIG. 6(c) to (i).

FIG. 6(c) shows a schematic illustration of estimating the real part of the refractive index.

In step S61, a reference waveform is obtained, and in S63 the reference waveform is time-gated to select the peak shown as S_{R} in FIG. 6(a). Said peak may be referred to as zero-order reflection. In S63b, the time-gated reference waveform is converted to the frequency domain to produce a reference spectrum (Ref).

In step S62, a sample waveform is obtained, and in S64, the sample waveform is time-gated to select the peak shown as S_{L} in FIG. 6(a). Said peak may be referred to as a zero-order reflection. In S64b, the time-gated reference waveform is converted to the frequency domain to produce a sample spectrum (R0).

In step S66, R0/Ref is determined. R0/Ref corresponds to the first ratio described previously. R0/Ref may be referred to as r(ω). R0/Ref is equivalent to rₐₗ (or r₁₂). Said spectrum may be referred to as the first spectrum.

In step S68, the estimate of the real part of the refractive index n is obtained. n is frequency dependent n(ω). The relationship between the refractive index and the ratio is obtained from Fresnel reflections as r(ω)=(1−n(ω))/(1+n(ω)).

FIG. 6(d) shows a schematic illustration of estimating the real part of the refractive index.

In step S71, a reference waveform is obtained, and in S73 the reference waveform is transformed to the frequency domain by performing a FFT, to produce a reference spectrum.

In step S72, a sample waveform is obtained, and in S74 the sample waveform is transformed to the frequency domain by performing a FFT, to produce a sample spectrum.

In step S76, the sample is deconvolved from the reference. The sample spectrum is divided by the reference spectrum. In step S77, (sample spectrum/reference spectrum) is converted to the time domain, by performing an inverse FFT, to produce a deconvolved waveform. An example of a deconvolved waveform is shown in FIG. 6(e). FIG. 6(e) shows the output of step S77. Note that the trace in FIG. 6(e) appears upside down in relation to that of FIG. 6(a) because reflections between low refractive index and high refractive index are negative. In FIG. 6(e), the baseline is flatter compared to FIG. 6(a) and three isolated peaks are visible.

Returning to FIG. 6(d), in step S79, the deconvolved waveform is time gated to select the zero order reflection R0. Referring to FIG. 6(e), the zero order reflection corresponds to the first peak, and corresponds to the reflection from the surface of the layer.

In step S81, the spectrum is obtained by taking a FFT. The spectrum in S81 corresponds to the first spectrum and relates to the zero order reflection R0 from the layer.

In step S83, the refractive index n (w) is estimated from the spectrum of S81, using the relationship r(ω)=(1−n(ω))/(1+n(ω)). Note that the spectrum of S81 here corresponds to r(ω). Note that this relationship is simplification used for normal incidence. The full equation is the Fresnel reflection equation.

FIG. 6(f) shows a schematic illustration of estimating a reflection spectrum. In particular the reflection spectrum relates to the reflection from layer substrate interface (peak S_{S} in FIG. 6(a)).

In step S90, a deconvolved waveform is obtained. The deconvolved waveform may be the waveform shown in FIG. 6(e) for example.

In step S92, the waveform is time-gated to select the first order reflection R1. R1 corresponds to the second peak shown in FIG. 6(e). R1 corresponds to peak S_{S} shown in FIG. 6(a).

In step S94, the spectrum of the time-gated waveform is obtained. The spectrum may be referred to as the R1 reflection spectrum. Said spectrum may be referred to as a second spectrum.

FIG. 6(g) shows a schematic illustration of estimating a reflection spectrum. In particular the reflection spectrum relates to the reflection from layer substrate interface (peak S_{S} in FIG. 6(a)).

In S400, an estimate of the real part of the refractive index is obtained. The estimate may be obtained using the approach of FIG. 6(c) or (d), for example.

In S402, the reference waveform is obtained, and in step S405, the reference spectrum (Ref) is obtained from the reference waveform.

In S407, the zero order reflection spectrum Ref is obtained, using the reference spectrum and the estimate of the real part of the refractive index. This calculation is based on the Fresnel relations. For example, using the expression described above where r(ω)=(1−n(ω))/(1+n(ω)), the zero order reflection spectrum of the reference may be obtained. From the real part of the refractive index the reflectivity from the air-layer interface may be calculated as r₁₂=(1−n)/(1+n). By multiplying the reference signal Ref by r₁₂, R0 is obtained. This is from R0/Ref=r12->R0=Ref*r12. This is a calculated version of the zero order reflection from the layer (that is, the reflection from the surface of the layer). This does not rely on time gating—therefore true for all times (unlike time-gated measured R0 described in relation to FIG. 6(b)). Therefore, by subtracting said R0 (once converted to the time domain as in S408) from the sample waveform, the ‘slow’ elements of R0 that would appear at the same time as R1 are removed.

In step S408, an inverse FFT is taken to obtain a time domain signal.

In step S404, the sample waveform is obtained. The sample waveform comprises S_{S} first order) and S_{L} (zero order) reflections. In step S410, the signal from S408 is subtracted from the sample waveform.

In step S412, the signal from S410 is time-gated to select the first order reflection R1, which corresponds to peak S_{S}. In step S414, an FFT is performed to obtain a spectrum of R1.

In step S416, the ratio of R1 to the zero order reference spectrum (Ref) is taken. The resulting ratio may also be referred to as the reflection spectrum of R1 and is denoted by R1/Ref.

FIG. 6(h) shows a schematic illustration of estimating the thickness of the layer.

In step S500, the R1 reflection spectrum is obtained. The R1 reflection spectrum may be derived using the approach of FIG. 6(f) or 6(g), for example. By R1 reflection spectrum it is meant the ratio of R1/Ref.

In step S502, the reflection spectrum is corrected for the layer surface reflection S_{L}. In step S504, a correction for the layer substrate reflection S_{S} is applied. The correction is as follows:
R1/Ref=t₁₂ t₂₁ rₗₛ is exp( ) is measured.
What is desired is I/I0=exp( ) therefore, in step S502, a correction for the surface reflection is applied as R1/Ref*(1/t₁₂/t₂₁). Here I/I0 refers to ratio of (actual signal/signal with no absorption).
Then, in step S504, a correction for the substrate is applied by multiplying by 1/rₗₛ (×1/rₗₛ), where rₗₛ is the reflection at the layer-substrate interface.
Therefore I/I0 is obtained and the absorption may be calculated.
The transmission t₁₂=1−r₁₂ and t₂₁=(r₁₂-1)−we know r₁₂ because we measure it.
Note that rₗₛ is obtained as described herein.

In step S506, the real and imaginary parts of the corrected spectrum are taken.

The propagation through a layer of thickness d is given by exp(−i.ñ·ω·d/c) this can be split into real and imaginary parts. The imaginary part (real n due to the factor of i) gives phase shift (time delay). From the phase shift=−n·ω·d/c, the thickness d may be calculated (since n is known). The real part (imaginary n) gives the exponential decay of the form exp(ω·κ·d/c). Therefore, from the ratio of the reflections In(S_{S}/S_{L})=ω·κ·d/c and can be rearranged to give K (imaginary part of refractive index).

In S509, from the real part S508, the absorption and the imaginary part of the refractive index K are obtained.

In S512, from the imaginary part S510, a phase shift is calculated, and from the phase shift, and the estimate of the ream part of the refractive index S511, the thickness is obtained. The thickness is frequency dependent.

In S513, a weighted average of the frequency dependent thickness is taken to produce a single thickness. For example, d(ω) may be averaged over values of ω where the measured data is of high quality (e.g. low noise).

FIG. 6(i) shows a schematic illustration of obtaining a model for the layer from the estimated complex refractive index. An estimate of the real and imaginary parts of the complex refractive index may be determined as described above. The estimate of the complex refractive index model is then fitted to a model. By model is meant a model of the refractive index of the layer. The model of the refractive index is then used in the subsequent optimisation step.

The initial frequency dependent estimate for complex refractive index (ñ=n+i·κ) is fitted to a model before any fitting is done to the waveform. For example, n(ω) and κ(ω), may be fitted to a Drude or Drude-Lorentz model. The model is then used in the subsequent optimisation step. The advantage of fitting to a model is that a physically realistic description of the reflection waveform is used in the subsequent optimisation step. A further advantage is that the number of parameters in the subsequent optimisation step is reduced. For example, for x frequency points, there would be 2× parameters to fit to (for real and imaginary parts of refractive index). By using a fitted model in the optimisation step, only the parameters of the model are varied (rather than having to vary the value of refractive index at each frequency point).

Referring to FIG. 4, steps S101 and S103 are concerned with obtaining an initial estimate of the parameters for the layer. Step S105 is concerned with optimising the value of the estimate. Step S106 is concerned with outputting properties of the layer based on the refined values of the parameters.

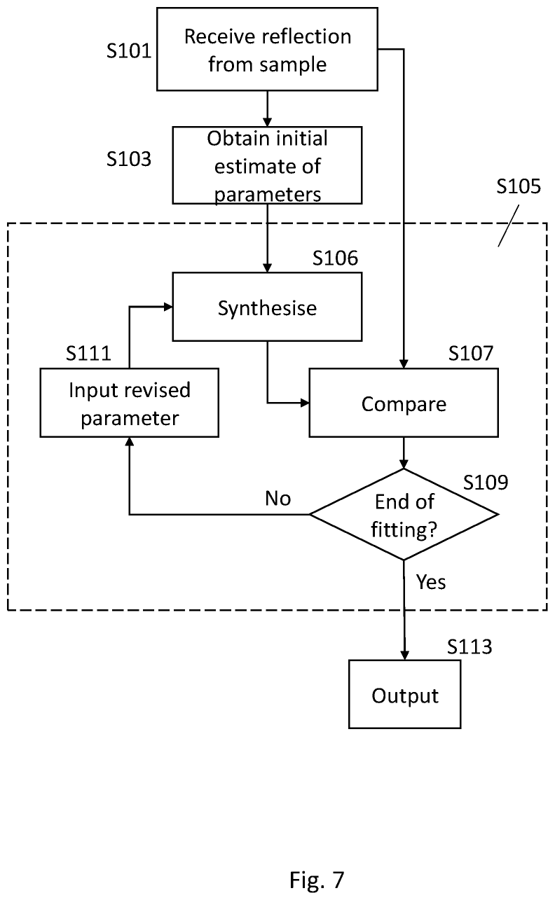

FIG. 7 shows a schematic illustration of the method for analysing a sample according to an embodiment. FIG. 7 shows step S105 of FIG. 4 in more detail. Step 105 is an iterative procedure performed to obtain a refined estimation of the parameters.

For example, Step 105 is a least squares fitting procedure.

In step S106, the initial estimate of parameters (n, κ, d) from S103 is used to synthesise a reflected waveform. To synthesise the reflected waveform, a model for the sample is assumed. For example, the model is formulated for a single layer on a metallic (reflective) substrate.

For example, for obtaining the initial estimate, the model is formulated for a single layer on a metallic (reflective) substrate. For a metallic substrate, there is no penetration onto the substrate.

The layer may be assumed to have a spatially uniform refractive index and thickness. For such a layer on a metallic substrate, the reflection may be computed using a matrix formalism of Fresnel equations.

A parameterised form of the complex refractive index is used in the iterative fitting procedure. For example, at least one of n and κ are parameters that are varied. By using a parameterised form of the complex refractive index, the number of degrees of freedom is reduced, and the fitting is simplified.

Optionally, the thickness d of the layer is another parameter that is varied during the fitting procedure.

Optionally, when the complex refractive index estimated in S103 is frequency-dependent, the model is also frequency dependent and uses a frequency dependent form of the complex refractive index. Additionally and optionally, the frequency dependence of the complex refractive index is identified in S103 and is used to select the refractive index model to be used in the fitting procedure.

In step S107, the synthesised signal is compared to the reflection received from the sample, to produce an error. The error may be a mean squared error for example. The error represents the difference between synthesised and measured signals. Note that the comparison may be made in the time domain or frequency domain. When comparing in the frequency domain, the measured signal (sample waveform) may be converted to the frequency domain to produce sample spectrum, and the synthesised signal is a frequency domain signal.

Optionally, the waveforms may be aligned in time so that reflection features (peaks and troughs) occur at the same point in time, to avoid blurring of reflection features. The time alignment is performed prior to fitting. For example the time alignment is performed prior to producing the error.

In step S109, it is determined whether a predetermined condition is met. If the condition is met, the iterative procedure ends and the method proceeds to step S113. The value of the parameters are provided to the output step S113.

If the condition is not met, the method moves to step S111, where the estimate of the parameters (n, κ, d) is revised, and the method returns to step S106. The range of values over which the parameters is to be swept is determined in advance. For example, the range may be determined by making prior measurements with known samples.

In step S113, an output is produced from the refined parameters (thickness and/or the complex refractive index of the layer). The output comprises at least one of the thickness, conductivity, or density of the layer. The thickness, conductivity, or density is obtained from the parameters of the layer as described herein.

In relation to step S106 and S107, it is noted that the iterative fitting procedure is carried out in the time domain (that is, using the received time domain reflection waveform, and a synthesised time domain reflection waveform). Time domain fitting provides improved accuracy when the layer thickness is important. This is because the layer thickness appears in the separation of the positions of the first peak (S_{L}) and second peak (S_{S}) in the time domain.

Alternatively, instead of a time domain formulation, the frequency response of the received reflection may be used. For example, a FFT may be performed on the reflected waveform received in S101 to obtain a frequency response. In step S106, a frequency response may be computed using a matrix formalism. In step S107, the difference between the frequency responses would then be obtained.

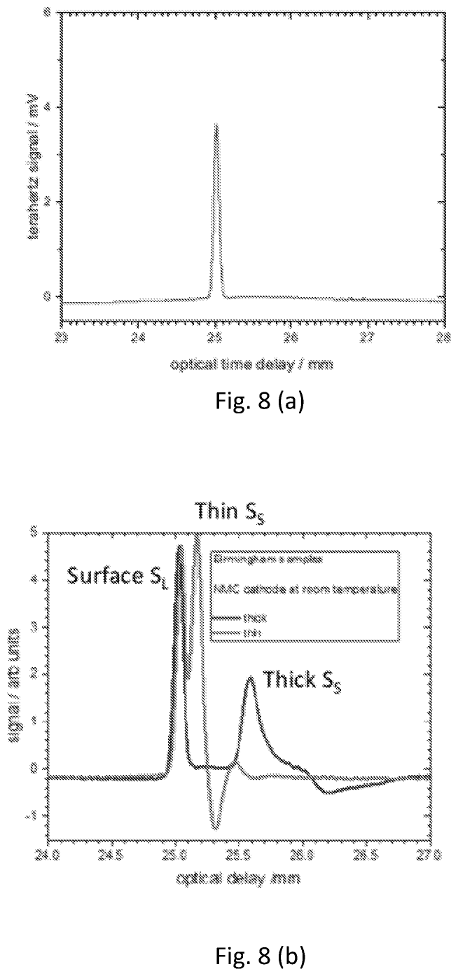

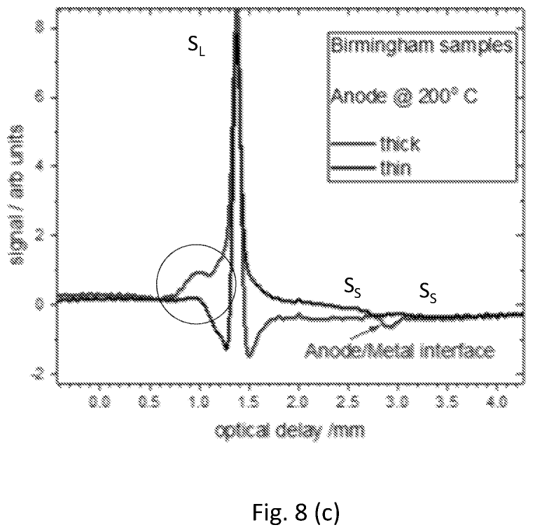

FIG. 8(a) shows a plot of a reflection waveform. The plot shows the reflection of the substrate divided by a reference. The substrate here corresponds to the uncoated substrate. The plot shows no other features than a surface reflection.

Note that this is different from the trace of the reference in FIG. 6(a), which was a raw waveform.

FIG. 8(b) shows a plot of a reflection waveform obtained from a cathode. The cathode comprises a metal substrate and a coating. FIG. 8(b) shows two traces, one for a thin coating (red, solid) and one for a thick coating (blue, dashed). Each trace comprises two reflection features, one for a surface reflection S_{L} and one for the coating-substrate reflection S_{S}. For the thin coating, the reflections features (the peaks) are separated by a smaller delay than for the thick coating.

FIG. 8(c) shows a plot of a reflection waveform obtained from an anode. The anode comprises a metal substrate and a coating. FIG. 8(c) shows two traces, one for a thin coating (black, solid) and one for a thick coating (blue, dashed). In the trace for the thin coating, the peak for the surface reflection S_{L} is apparent. The feature corresponding to the anode-metal interface S_{S} is also visible (marked by an arrow). For the thick coating, the peak for the surface reflection S_{L} is again apparent, while the feature corresponding to the anode-metal interface S_{S} is present (marked by an arrow) but it is more subtle than in FIG. 8(b), for example. Further, in the thick anode, a further third structure (indicated by a dashed circle), is distinguishable. It is believed the further structure indicates an additional layer or other interface.

The measurement of layers that are opaque—due to strong absorption or other effects—is challenging because a smaller amount of signal penetrates through the film and is reflected back to the detector.

The inventors of the present invention have configured the sensor 3 of the system 1 such that a suitable depth of focus that allows the reflections to be detected, and the parameters of the layer to be estimated. The depth of focus is configured such that the beam reflected from the coating-substrate reflection S_{S} is detectable.

With films having a high refractive index (due for example to high conductivity or other sources), changes in divergence of the beam will be affected away from the focal point of the beam by a different amount from that expected for low index materials (where n˜1).

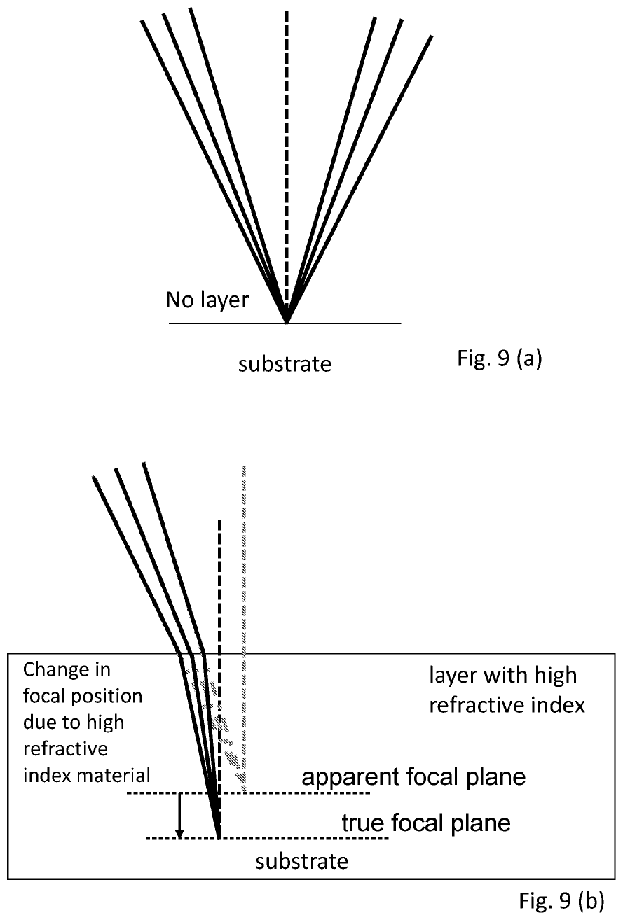

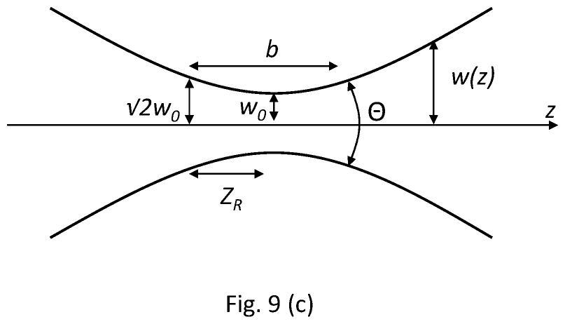

FIG. 9(a) shows a schematic illustration of a beam focussed at a surface of the substrate when no sample is present.

FIG. 9(b) shows a schematic illustration of the change in the focus of the beam of FIG. 9(a) when a sample is introduced. The beam without the sample is shown in dash-dot (-.-) grey lines. The beam with the layer introduced is shown in FIG. 9(b) in solid lines. The layer has a high refractive index and the beam (solid lines) illustrates that the focus has moved both away from an outer (upper) surface of the layer and laterally.

Materials with refractive index >1 shift the focus position. This is particularly acute in materials that have high conductivity (such as conducting coatings used on electrodes in batteries). For example, anodes have a terahertz refractive index >˜6. The higher refractive index moves the focus away from the front surface of the layer under examination and laterally from the nominal focus position. This has the effect of moving the focal point, effectively taking the system out of focus and alignment. The higher the refractive index, the larger the shift in focus and the larger the misalignment.

FIG. 9(c) shows a schematic illustration of a beam width w(z) as a function of the distance z. FIG. 9(c) illustrates an example of a Gaussian beam. The beam waist w₀ is the beam size at its focus (i.e. z=0).

The beam width varies as w(z)=w₀[1+(z/z_{R})²]^{1/2}. Here z_{R} is the Rayleigh range and is given by z_{R}=πW₀²n/λ, where n is the index of refraction and Δ is the wavelength of light. b is the confocal parameter and b=2z_{R}. The confocal parameter and the Rayleigh range relate to the depth of focus. A point within the confocal parameter may be considered to be in focus. A point within the confocal parameter may be resolved by the optical element.

The beam waist w₀ relates to the lateral resolution. Small spot sizes (small w₀) are used to increase the lateral resolution (in the horizontal plane). A small spot size means that there is a corresponding reduction in focal depth z_{R}.

Conventionally, in terahertz imaging, small w₀ (and hence small focal depth) has been used.

The inventors have realised that using a longer focal depth should enable the two interfaces of a layer on a substrate to be in focus. A lens having a longer focal for the same aperture has a larger depth of focus. SUCh an arrangement enables the sample interfaces to remain in focus, and has proven key to detecting reflection from both interfaces in high refractive index layers such as those characteristic of coatings used on cathodes and anodes in lithium ion and other types of batteries

In high resolution imaging, a lens with a short focal length lens with a large aperture would be used. This would give a small spot size but a small depth of focus˜2.44 fλ/a.

Here, f is the focal length and a is the limiting aperture of an optic system. The ratio f/a is known as the f-number. For a fixed aperture a, the larger the focal length f, the longer the f-number, and the larger the depth of focus.

To enable the two interfaces of a layer on a substrate to be in focus, the inventors have configured the optic system to have an f-number such that the two interfaces remain in focus. In other words, the f-number is adapted such that the confocal parameter is greater than or equal to the thickness d of layer (l).

In an embodiment, the f-number is greater than 3.

In another embodiment, the f-number is greater than 4. In another embodiment, the f-number is greater than 5. In another embodiment, the f-number is greater than 6. In another embodiment, the f-number is greater than 7. In another embodiment, the f-number is greater than 8. In another embodiment, the f-number is greater than 9. In another embodiment, the f-number is greater than 10.

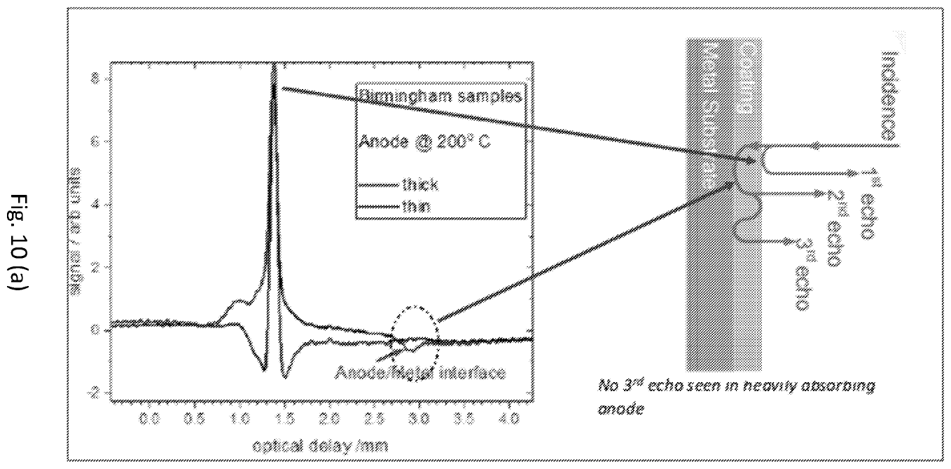

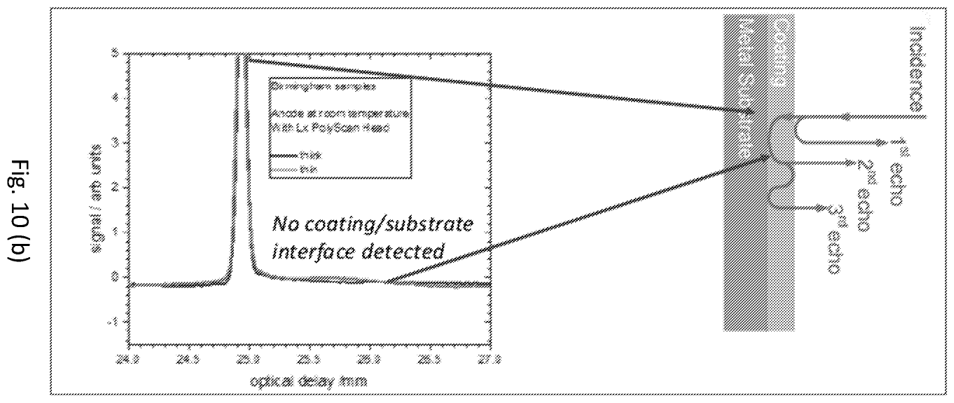

FIG. 10(a) shows a schematic illustration of the using an optical system with a large f-number. Here the f-number is 10 (which may be represented by f/10). The sample is the anode described in FIG. 8(c). With the f/10 lens, the reflection from the surface of the coating and from the coating-substrate interface are resolved and appear as features in the reflection waveform in the trace for the thick and thin samples. FIG. 10(a) shows a reflection waveform acquired using a slower optical system (f-number=10) where the depth of focus is larger along the optical axis (z). The reflection S_{S} can be identified, allowing the film thickness to be estimated.

FIG. 10(b) shows a schematic illustration of the using an optical system with a small f-number. Here the f-number is 3 (which may be represented by f/3). The sample is the same as for FIG. 10(a). With the f/3 lens, the reflection profiles for the thin and thin samples appear similar. Both show the reflection from the surface of the coating. However, the feature from the reflection at the coating-substrate interface is not resolved and does not appear in the reflection waveform.

In FIG. 10(b), the optical system comprise a faster optic (f-number=3) and a correspondingly smaller depth of focus on the optical axis, the reflection at the coating-substrate interface is not resolved.

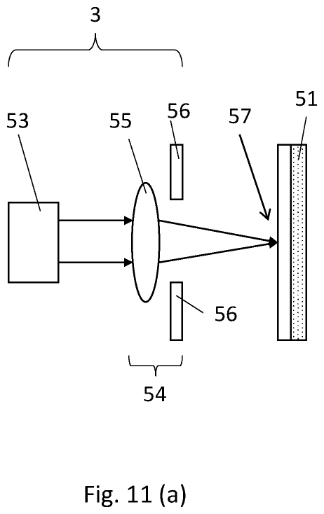

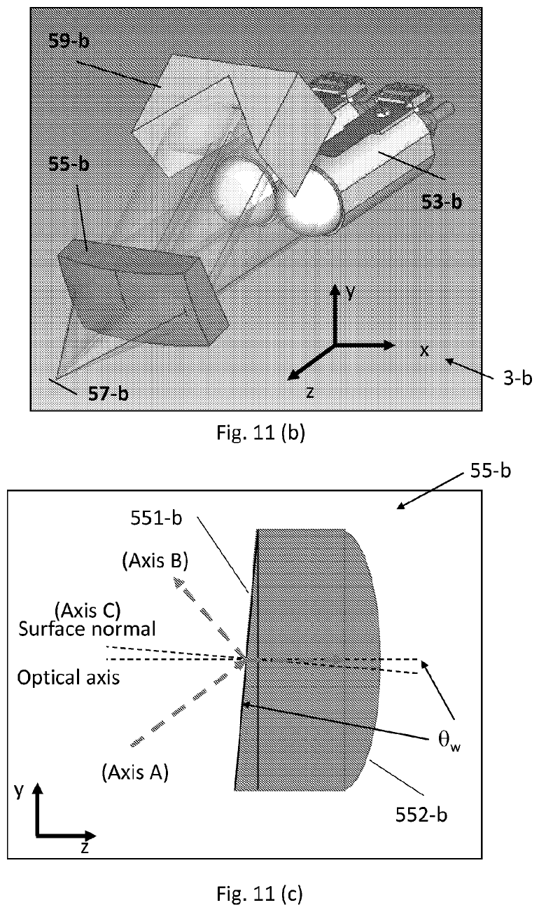

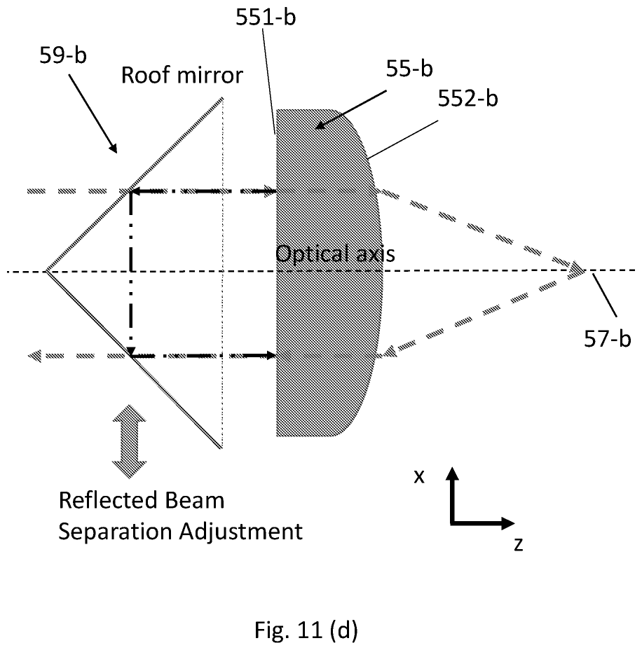

FIG. 11(a) shows a schematic illustration of the internal configuration of a terahertz sensor 3 measuring a sample 51. The sample 51 corresponds to sample 200 described herein, for example. The sample is provided at the focus of the terahertz sensor. The terahertz sensor comprises a unit 53 which both emits and detects terahertz radiation. The radiation when leaving the terahertz unit is brought to focus by an optical element 54 at the focal plane 57 in the vicinity of the sample 51. The optical element 54 comprises a focussing element 55 and an aperture 56. The focussing element 55 may be a mirror, or a lens. The focussing element 55 has a focal length f. An aperture 56 is also provided. The aperture 56 has an aperture size a. The focussing element 55 and the aperture 56 together define the f-number of the optical element. The focussing element 55 and the aperture 56 are referred collectively as the optical element 54.

In an embodiment, the f-number of the optical element is adjusted by changing the focussing element 55 to one having a different focal length. The aperture 56 is fixed.

Additionally or alternatively, the f-number of the optical element is adjusted by changing the aperture 56 to change the aperture size a.

Changing the focal length of the focussing element rather than the aperture avoids reducing the power. However, the aperture may still be limited.

As described above, an instrument response may be determined. The instrument response is determined in a separate measurement, where a plane mirror (not shown) is provided at the focus 57 to allow the terahertz beam to be reflected back from the focus to the detector in unit 53. Alternatively, instead of the plane mirror, an uncoated substrate may be used.

Additionally and optionally, the arrangement of FIG. 11(a) comprises a polariser. The polariser may be placed between the terahertz unit 53 and the lens 55, for example. The polariser may alternatively be placed at other positions in the path of the beam. The emitter and detector of the terahertz unit 53 may be highly polarised and may emit in one polarisation. The addition of the polariser enables the relevant polarisation to be considered and improves the accuracy of the detected signal.

As an alternative to including a polariser, the sample may be irradiated using a P-polarised beam and then measured at the Brewster angle in P polarisation. SUCh a measurement gives a direct measure of the imaginary part of the complex refractive index.

FIG. 11(b) shows a schematic illustration of the internal configuration of a terahertz sensor 3-b. The terahertz sensor 3-b comprises a terahertz unit 53-b which both emits and detects terahertz radiation. For example, the terahertz unit 53-b comprises an emitter and a detector.

The focussing element 55-b is a lens. For example, the focussing element 55-b is a silicon lens. The terahertz sensor 3-b further comprises a mirror 59-b. The mirror 59-b may also be referred to as an internal reference mirror, internal mirror, or a roof mirror.

Terahertz radiation may be emitted in the form of pulse. The pulse may comprise a plurality of frequencies in the range from 0.01 THz to 10 THz.

The lens 55-b, unit 53-b and mirror 59-b are configured such that radiation emitted by unit 53-b is incident upon the lens 55-b. Some of the radiation incident on the lens 55-b is transmitted by the lens 55-b to a point 57-b. Point 57-b is the focal point of the lens. Some of the radiation incident on lens 55-b is reflected towards mirror 59-b.

In use, a sample is provided at the focal point 57-b. The radiation incident on the sample is reflected back into the lens and towards terahertz unit 53-b where it is detected. The path travelled by the radiation may be referred to as a transmitted path. The radiation that travels through the transmitted path is dependent on the sample. The sample may be any of the samples described herein.

Some of the radiation incident on lens 55-b is reflected towards mirror 59-b. Δt the mirror 59-b, the reflected radiation is directed towards the lens 55-b. The reflected radiation is further directed by the lens 55-b towards the terahertz unit 53-b where it is detected. The path travelled by the radiation may be referred to as a reflected path. The radiation that travels through the reflected path is independent of the sample. Said radiation provides an internal reference.

The mirror 59-b may be a roof mirror. The roof mirror 59-b may also be referred to as roof reflector, or roof mirror reflector or prism.

FIG. 11(c) shows a schematic illustration of the lens 55-b. The lens 55-b comprises a back face 551-b and a front face 552-b. Radiation from the terahertz unit 53-b is incident on the back face 551-b of lens 55-b. The back face 551-b comprises a planar surface. Some of the incident radiation is reflected while some is transmitted through the lens and out through the front surface. The incident, reflected and transmitted radiation is shown in dashed lines. The reflected radiation is transmitted towards the mirror 59-b and follows the reflected path described above. The transmitted radiation is transmitted towards a sample, in use. Said radiation follows the transmission path described above.

The back face 551-b of the lens 55-b is cut at a wedge angle to the optical axis. This leads to an optical arrangement as follows:
The angle between optical axis of the lens 55-b and a back face 551-b of the lens is θ_{w}, which is the wedge angle.
The angle between incident (and reflected) beam and surface normal is θᵢ
When the relation sin (θᵢ)=nₛᵢ sin (θₜ), where nₛᵢ is the refractive index of the lens, is satisfied, the transmitted beam is transmitted on the optical axis.
The incident and transmitted beam are θᵢ+θ_{w} and θᵢ−θ_{w} with respect to the optical axis respectively.

FIG. 11(d) shows a schematic illustration of the lens 55-b and mirror 59-b.

In the figure, the transmitted beam path is illustrated by way of dashed lines (- -). The reflected beam path is illustrated by way of dash-dot-dot-dash lines (-..-).

In the transmitted beam path, incident radiation impinges upon the back surface 551-b of the lens, propagates through the lens 55-b, and emerges out of the front surface 552-b of the lens where it is focussed at point 57-b. The front surface 552-b of the lens comprises a convex face. The convex face is adapted to focus a beam at a focal point 57-b.

In use, a sample is provided at the focal plane 57-b. The radiation is reflected towards the front surface 552-b of the lens 55-b, propagates through the lens 55-b, emerges out of the back surface 551-b of the lens, and is directed towards the terahertz unit 53-b where it is detected.

In the reflected beam path, incident radiation impinges upon the back surface 551-b of the lens, where it is reflected towards the mirror 59-b. At the mirror 59-b, the radiation is directed back to the back surface 551-b of the lens, where is directed towards the terahertz unit 53-b for detection.

The x-axis separation of the beams may be set to permit the THz emitter and detector devices to be conveniently placed side-by-side.

The roof mirror position along the x-axis determines the x-axis separation of the beams (FIG. 11-d) and is chosen such that the x-axis offset of the reflected beam matches the x-axis offset of the transmitted beam when the beams arrive at the THz unit 53-b such that the two beams arrive at the terahertz unit 53-b at the same position.

The reflected beam that is reflected from the back surface 551-b of the lens 55-b is indicated by a dash-dot-dot-dash line (-..-) in FIG. 11(d).

The roof mirror is configured such that a beam reflected by the mirror is parallel to an incident beam.

The beams between the THz unit 53-b and the lens 55-b define a first axis, axis A.

The beams between the back surface 551-b of lens 55-b and the roof prism 59-b define a second axis, axis B.

As shown in FIG. 11(c) the lens planar surface normal defines a third axis, axis C. Axis C does not align with the lens optical axis.

FIG. 11(c) also illustrates a fourth axis, which is the optical axis.

The angle between axis A and axis C is equal to the angle between axis B and axis C (axis A∠axis C=axis B∠axis C) such that A and B lie on opposite sides of the surface normal C. That is, B is the axis for specular reflection of a beam incident along axis A by the surface with normal C.

The path length of the reflected beam is adjusted by moving the roof mirror 59-b along its axis B such that the total path for the reflected beam is somewhat shorter than the total path for the transmitted beam.

The purpose of the shorter reflected path is that the reference signal (that is the signal that takes the reflected path) arrives before the sample signal (that is the signal that takes the transmitted path). This allows the reference signal to be detected independently of the sample signal using a single transmitter and receiver (detector).

The reference signal is therefore acquired together with the sample signal. By being acquired together, it is meant that the reference signal is measured as part of the same waveform as the sample signal. However, the measurement has a finite duration. The reference signal provides an internal reference, and allows correction of short term system signal variation.

Note that, optionally, for calibrated measurements, the internal reference is corrected with external reference. The external reference is obtained by placing a gold mirror at sample position and measuring the reflected signal. The external reference may be used to correct the internal reference.

The correction may be performed as follows.
The signal from the external gold mirror reference may be represented by R_{E}; the signal from the internal reference may be represented by Rᵢ, and the signal from the sample may be represented by S. t₀ represents the time when the external mirror is measured. t₁ represents the time at which the sample is measured.
With the external gold mirror reference R_{E}(t₀) and internal reference Rᵢ(t₀) and sample measurement S(t₁) and internal reference Rᵢ(t₁) measured at t₁ then a correction for the measurement can be taken.
The sample to Mirror reference is then S/R_{E}=S(t₁)/R_{E}(t₀)×Rᵢ(to)/Rᵢ(t₁).
Similarly, the sample measurement can be corrected as:

S=S(t₁)×Rᵢ(t₀)/Rᵢ(t₁)

The configuration of FIG. 11(d) allows improved signal intensity stability to be obtained. The configuration also enables measurement of a sample path optical delay independently of the system optical delay drift. This allows the signal amplitude variations due to focus variation to be corrected.

The sensor 3-b described in relation to FIG. 11(b), and the components described in relation to FIGS. 11(c) and (d) enable the signal amplitude to be measured with improved accuracy.

For example, while long term system drift can be removed by standard referencing, standard referencing involves interrupting the sample measurement while another reference is taken. The configuration of FIGS. 11(b) to 11(d) is self-referencing. This configuration maintains the accuracy of the measurement while avoiding interruptions in the sample measurement. The sensor 3-b provides an arrangement where the sample (transmitted path) and the reference (reflected path) can be measured together, without interrupting the sample measurement.

For example, the position of the sample relative to the focus of the lens also has effect on signal amplitude. The configuration of sensor 3-b enables this to be measured and calibrated out using peak position (optical delay), but only if other optical delay variation is removed. The sensor 3-b enables this to be performed as the delay between the internal reference pulse and the sample pulse is independent of system optical delay variation.

Thus, the sensor 3-b described in relation to FIGS. 11(b) to (d), enables the signal amplitude to be measured accurately. The sensor is also capable of continuous operation whilst maintaining accuracy because sample measurements do not have to be interrupted to obtain a reference measurement.

In turn, this enables accurate measurements of real n and thickness of a layer to be performed since the measurement of real n and thickness requires an accurate measurement of the signal amplitude. This becomes more important with samples with high refractive index (since dr/dn reduces at high n). Here r represents the Fresnel reflection at an interface of the layer.

The sensor 3-b is combinable with any of the systems and methods described herein. For example, sensor 3-b may be used instead of sensor 3 in the system of FIG. 3 or in FIG. 11(a).

When sensor 3-b is used in the arrangement of FIG. 11(a), the focal length of the lens 55-b may be varied by adapting the front surface 552-b of the lens 55-b. For example, a radius of curvature of the convex face may be adapted.

When sensor 3-b is used in the arrangement of FIG. 11(a), the focal length of lens 55-b and the aperture set the f-number.

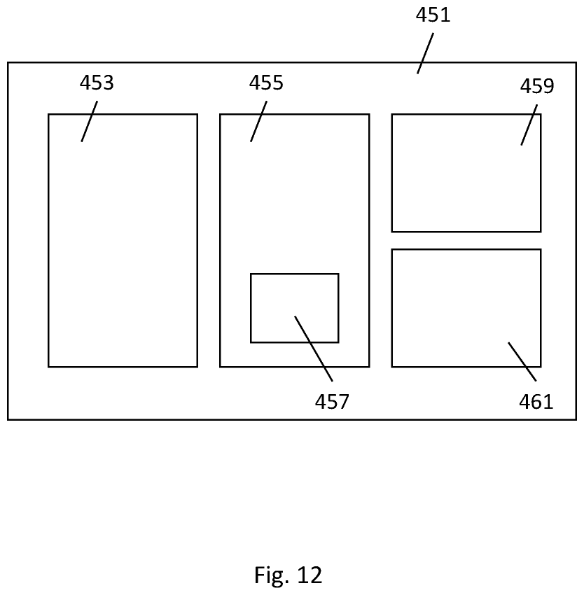

FIG. 12 shows a schematic illustration of an analysis unit.

The analysis unit 451 may correspond to the analysis unit 5 of shown in the system of FIG. 3. The analysis unit 451 may implement any of the methods described herein.

The analysis unit 451 can determine the thickness of the layers in real time or the data can be saved by the analysis unit and processed at a later time. The analysis unit 451 which can be embodied on a standard computer comprises a memory 453, a processor 455 running a program 457 in addition there is an input module 459 and an output module 461.

In an embodiment, the input module 459 receives data from the sensor 401 the input is in the form of a time domain terahertz trace. This data is then passed to processor 455 which runs program 457. During the determination of the instrument response, the data that is passed to input module 459 is processed by processor 455 and saved to memory 453. When analysing data from a sample, the processor 455 calls the instrument response from memory 453 to derive a sample response. The output is provided by output module 461. In a further embodiment, the processor 455 is a multi-core processor. This allows much faster processing by calculating thicknesses in parallel using multiple cores of the PC.

### Battery

Terahertz techniques described herein may be used to measure quantities such thickness, weight, density and conductivity of coatings used on electrodes in the development and manufacture of lithium-ion batteries. Lithium-ion batteries are currently used to power most of the world's portable electronic devices, such as smartphones, laptops, and tablets, and are increasingly used in hybrid and electric vehicles (EVs), as well as nation power grid storage for renewable energy.

An important challenge in lithium-ion battery production is to optimize the manufacturing process for electrode coatings (cathode & anode) to improve and optimise capacity whilst reducing and controlling manufacturing costs. Parameters to optimise during coating production comprise changing the coating gap, line speed and others. Other performance indicators that determine electrode performance include coating density, coating thickness and conductivity.

The methods and systems described herein enable the coating thickness and at least one of the coating density and conductivity to be measured accurately and rapidly.

Further, the methods and systems described herein enable these quantities to be measured simultaneously using one sensor.

### Electrode Manufacturing Process

An important challenge in battery production is optimisation of the manufacturing process to improve long-term cycling performance and capacity lifetime whilst reducing and controlling manufacturing costs. A key step in production, which determines the final quality of the battery pack, is the manufacturing process for the electrodes, with emphasis on the quality and consistency of the coatings used on both cathodes and anodes.

The manufacture of electrodes may comprise three steps: coating, drying, and calendaring.

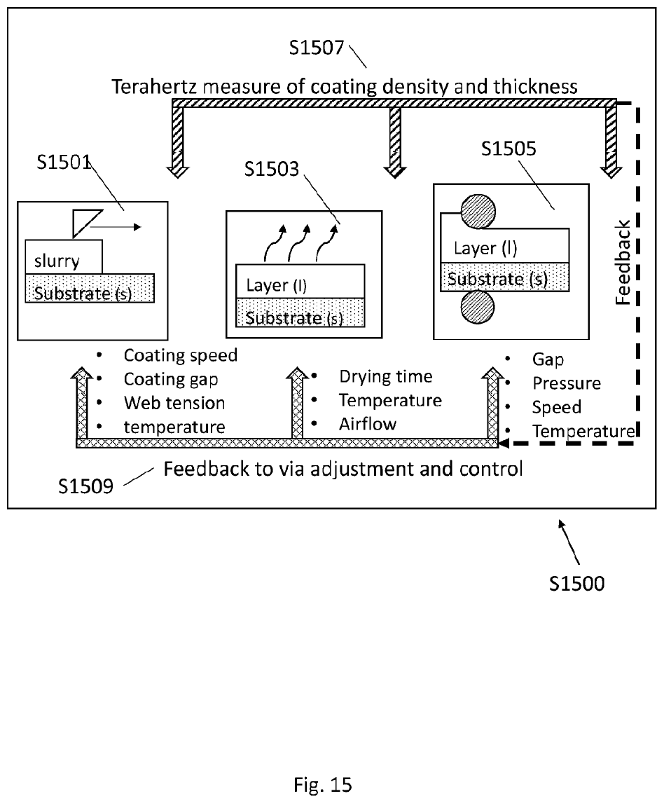

FIG. 15 shows a schematic illustration of a method S1500 of manufacturing an electrode according to an embodiment. FIG. 15 illustrates key stages and parameters in the production of electrode coatings, and the feedback control of production using coating thickness and density measured by Terahertz sensors at different parts of the process.

There are a number of stages in the production process of both cathodes and anodes where Terahertz sensors could play a role in process control and reducing wastage; see FIG. 15. An in-line configuration may measure coating thickness and density, and feedback these parameters to control the coating speed and gap. There is additional value in making these measurements both before and after drying. Comparing the wet thickness to the applied gap will give information about the elasticity in the process. The dry coat density and thickness will dictate the capacity of the coating and so will be the ultimate factor to optimise by changing the gap and speed of coating production.

Step S1501 illustrates the coating step. In the coating step, a layer (coating) is deposited on the substrate. The substrate acts as a current collector. In the coating step, current collectors, which are typically aluminium for cathodes and copper for anodes are coated. The coatings are a slurry mixture comprised of active materials, Lithium nickel manganese cobalt oxides LiNi—MnCo (NMC), or Lithium Nickel Cobalt Aluminium Oxide (NCA) or Lithium Iron Phosphate (LFP) or Lithium Cobalt Oxide (LCO) or Lithium Manganese Oxide (LMO) can be used in a typical lithium ion cathode and graphite for an anode. The coating may also include conductive carbon nanoparticles (e.g. carbon black), a polymer binder and a solvent. It should be recognized that the methods and inventions described here can apply to any type of active material used in coatings for cathodes and anodes, and are not limited to the examples given here.

Step S1503 illustrates the drying step. In the drying step, the mixture is then dried by exposure to airflow, heat, or other processes. Another example of the process is described in Duffner, F., Mauler, L., Wentker, M., Leker, J. and Winter, M., 2021. Large-scale automotive battery cell manufacturing: Analyzing strategic and operational effects on manufacturing costs. International Journal of Production Economics, 232, p. 107982.

Step S1505 illustrates the calendaring process. In the calendaring process, the dry coating is compressed to increase the energy density of the cell via a reduction in porosity, but leaving sufficient porosity for lithium transport and other forms of conduction (see Journal of Power Sources 393 (2018) 177-185).

In Step S1507 performance indicators of the electrode are measured. The performance indicators are measured using terahertz radiation using the systems and methods described herein.

In Step S1509, the measurement(s) from S1507 are fed back to adjust and control the manufacturing process. Each step of the manufacturing process is controlled by process conditions.

For S1501, the process conditions are coating speed, coating gap, web tension, and temperature. Any one of the process conditions of coating speed, coating gap, web tension, and temperature of step S1501 may be adjusted, for example.

For S1503, the process conditions are drying time, temperature, and airflow. Similarly, any one of the drying time, temperature, and airflow of step S1503 may be adjusted. For S1505, the process conditions are gap, pressure, speed and temperature. Any one of the gap, pressure, speed and temperature of S1505 may be adjusted.

Although FIG. 15 illustrates that the S1507 is performed after each of S1501 (coating), S1503 (drying) and S1505 (calendaring), it will be understood that the measurement of S1507 may be performed after any one of or any two of the steps of coating, drying and calendaring.

Similarly, although FIG. 15 illustrates that feedback S1509 applied to the three steps of coating, drying and calendaring, it will be understood that feedback may be applied to any one of or any two of the steps of coating, drying and calendaring.

The performance indicators in the electrode production process that allow the homogeneity, quality and performance of the cathode and anode coatings to be continually optimised, monitored and maintained comprise the following.
Density of the coating—important towards maximising the energy density of the battery cell but leaving sufficient porosity for lithium transport and other conduction mechanisms. The mass of active material per unit area dictates the final capacity of the electrode and while higher coat weights are desirable to increase energy density, they typically also lower the power density. Hence there needs to be a compromise between the two, giving the maximum energy density while satisfying the power requirements needed for the application. For this reason, specific control of the coating density is highly desirable. Density is thus a key variable in dictating electrochemical properties of coatings.
Thickness of the coating—ensuring the homogeneity of coating thickness in the production process and final product. Thicker electrodes contain a greater amount of active materials, increasing energy density, but also have greater diffusion distances, lowering power output, as well as potentially causing uneven response across the electrode and leading to quicker degradation. Hence, there exists an optimum thickness to balance these effects, and control over the thickness is important (see Materials & Design 209 (2021) 109971).
Conductivity of the coating—high conductivity improves the capacity at higher discharge rates, with more energy extracted from the battery at a given time (see https://undergraduateresearch.virginia.edu/investigating-conductivity-lithium-ion-batteries-across-porous-thin-films-through-manipulation-0).

In step 1507, any one or more of these performance indicators may be measured.

Measuring the above performance indicators may be performed at the following points of the production process:
Before or after the coating drying process (S1503) when the coating has been applied to the current collector metal substrates. The coating and drying process alone are currently reported to make up 22% of the total cost of electrode manufacture (Materials & Design 209 (2021) 109971).
Before or after the calendaring process (S1505) when the dry coating is compacted.

In Step S1507, the performance indicators of the electrode are measured using terahertz radiation using the systems and methods described herein.

The advantage of using the systems and methods described herein is that key performance indicators above may be rapidly monitored in the production of electrode coatings, and real-time feedback may be provided for process control.

For example, improved process control may eliminating wastage costs and ensuring supply to market without production stoppage. For example, losses in the manufacturing of lithium-ion batteries due to scrappage of out-of-specification electrodes can runs as high as 2-5% of output (see Journal of Minerals, Materials and Metals 69 (2017) 1484-1496, and Int. J. Prod. Econ. 232 (2021) 107982), with even higher numbers possible at the ramp-up of new manufacturing runs. This wastage contributes overall battery cost, and becomes very significant as production is scaled up in giga factories.

Another advantage of using the systems and methods described herein is that key performance indicators above may be measured simultaneously.

Different techniques have been used for monitoring the above performance indicators in the manufacturing process for lithium-ion electrodes. Note of these techniques provide all of the key performance indicators noted above. These techniques are often used in isolation and tend to be used as off-line as quality control measures. Off-line techniques such as sampling and weighing a coated electrode vs. uncoated substrate are also used. However, on large scale production, the off-line trial-and-error approach can lead to much additional wastage and equipment downtime.

None of the techniques can measure coating density, thickness and conductivity in-line directly and simultaneously. For example, laser triangulation or laser callipers at near infrared wavelengths can be used to estimate thickness but are difficult to implement with opaque coatings and frequently require calibration to uncoated substrates as well as maintaining precise alignment in production environments, which leads to inaccuracies. Sensors are available to measure coating weight. X Ray, beta and gamma radiation can be used in transmission and reflection geometries but suffer from both safety concerns as well as the need (in the case of beta sensors) to integrate over long timescales to collect accurate signals. For the high coating speeds used in industry, this can cause significant areas of the coating to be missed. Ultrasound can also be used to measure the weight of coated material but relies on stable and accurate calibrations. Moreover, in all of the above, the coating weight is measured and not the coating density which is the desired performance indicator. Coating density can be calculated and thus indirectly estimated but relies on measurements of thickness from yet another set of sensors, introducing further errors.

The systems and methods described herein enable direct and simultaneous measurement.

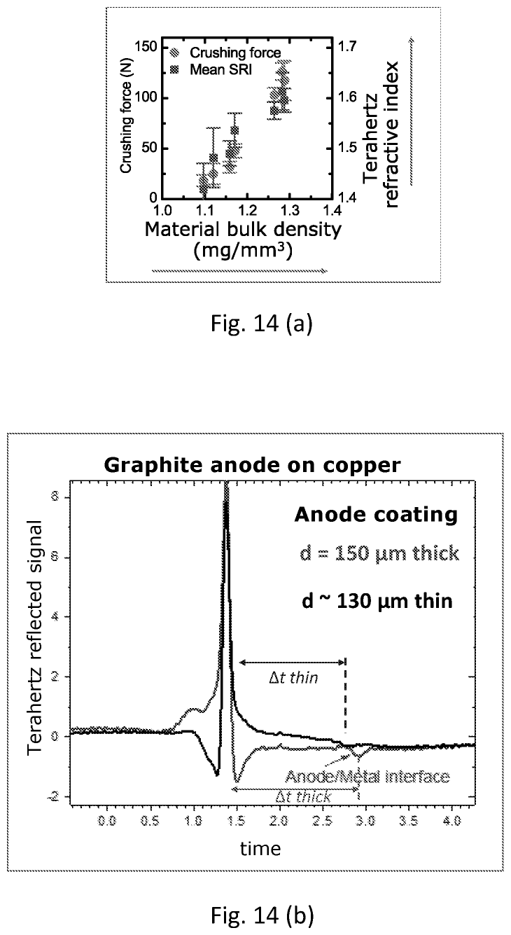

An additional and substantial advantage of Terahertz over other techniques is its ability to simultaneously measure the real (n₀) and imaginary (k) parts of the refractive index of the coating, n=n₀+ik. This unique capability of Terahertz pulses provides important information on key performance indicators for the coating
Thickness of the coating: Coating thickness d can be calculated using the formula d=cDt/2n where c is the speed of light, n is the index of refraction and Dt is the time delay of the Terahertz pulse from the coating interface; see FIG. 1.
Density of the coating: The real part of the index of refraction no of a material in the Terahertz is proportional to the bulk density of the material (Journal of Pharmaceutical Sciences On-line DOI 10.1002/jps.23560 (2013)) and can be used to directly measure the density with the aid of calibration; FIG. 14(a) shows a plot of the variation of refractive index with bulk density.
Conductivity of the coating: The imaginary part of the index of refraction k of a material in the Terahertz is related to its high frequency conductivity σ using the equation σ (ω)=2n₀ke₀w, where w is the Terahertz frequency, enabling the electrical properties of the film to be monitored and adjusted during the production process, or to be used off-line in the modelling and prediction of the process.

The systems and methods described herein also enable an in-line approach to be implemented. In-line techniques survey more of the coating than taking sample points and often offer improved detection of faults in the coating through more extensive inspection. Rapid in-line measurements also offer the opportunity for real time process control as noted above, with cost reduction and insurance-of-supply benefits.

In an embodiment, a single sensor is used for both in-line thickness and coating density measurements. This sensor would allow in-line control by feeding back the coating thickness and density in real-time into the coating deposition control process (e.g. modifying the speed of the production line, gaps used in deposition system, etc.) to optimise coating and maintain quality. Thus far, this in-line process has not proven possible with the measurement technologies mentioned above.

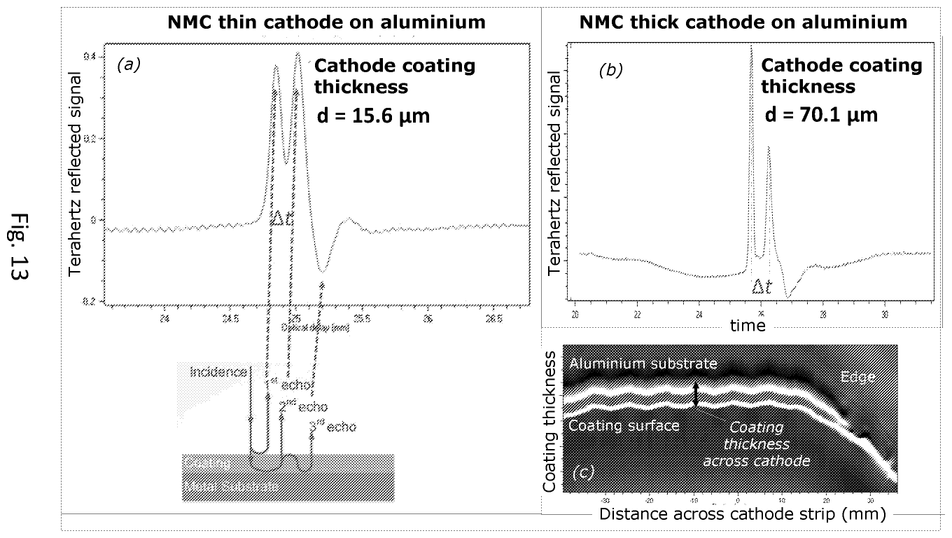

FIG. 13 shows the terahertz measurement of cathodes based on NMC (Lithium-Nickel-Manganese-Cobalt-Oxide (LiNiMnCoO₂)) on aluminium. To illustrate the wide range of the Terahertz measurement, both thin (15 μm) and thick coatings (70 μm) were investigated. The twin peaks in the Terahertz waveforms are shown to illustrate the ease with which the front and rear interfaces of the coating are resolved and coating thickness correctly measured, but in a production system a simple value of coating thickness is automatically returned to the operator or plant data management system. A scan of the Terahertz sensor across the width of the cathode reveals the surface and coating profiles, as well as a linear plot of coating thickness itself across the cathode. FIG. 13(a) shows Terahertz measurements of NMC coating on aluminium with a thin coating. FIG. 13(b) shows Terahertz measurements of NMC coating on aluminium with a thick coating. FIG. 13(c) shows a cross sectional image of coating thickness across the cathode, demonstrating the ability of Terahertz to measure and map thickness across cathodes used in lithium-ion batteries.

FIG. 14(b) shows a Terahertz measurement of anode coatings based on graphite mixed with carbon black and binder on copper. To again illustrate the wide range of the Terahertz measurement, measurements on both thin (130 μm) and thick (150 μm) coatings are shown. Graphite is more absorbing in the Terahertz, but two peaks in the Terahertz waveforms are nevertheless resolved, identifying the front and rear interfaces of the coating and correctly returning the coating thicknesses.

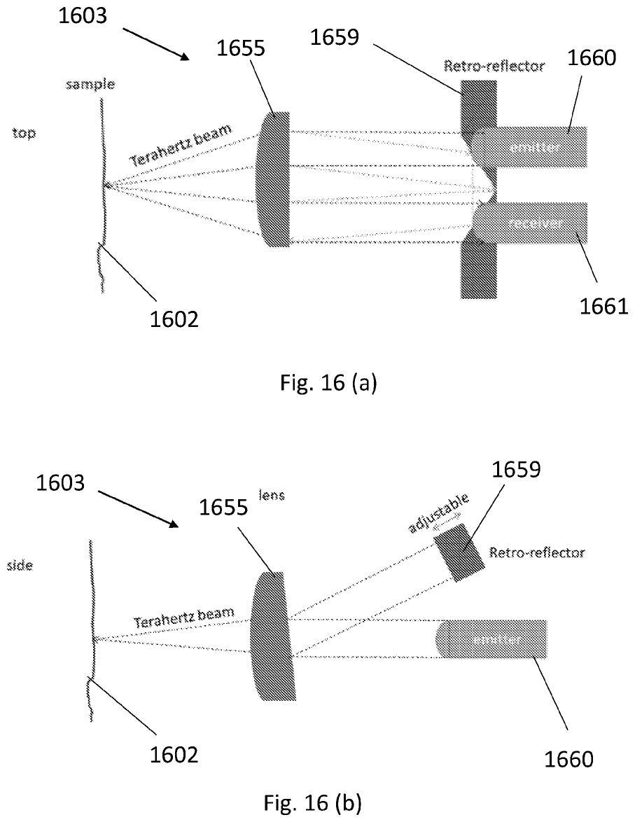

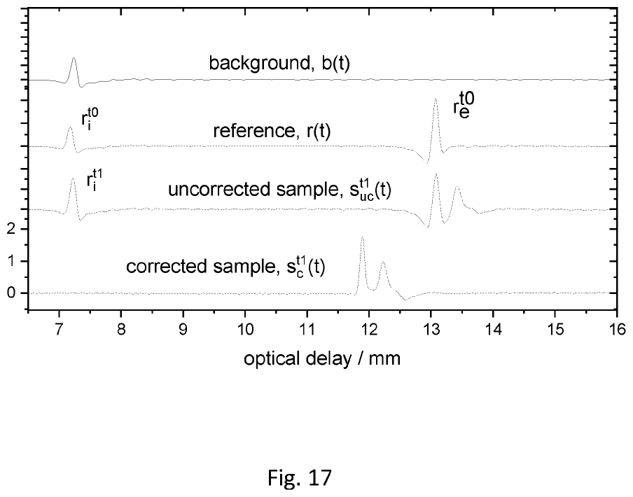

Another example of a sensor 1603, having a self-referencing (SR) mechanism in a linear configuration, is described below and with reference to FIGS. 16(a), 16(b) and 17. The sensor 1603 is combinable with any of the systems and methods described herein. For example, sensor 1603 may be used instead of sensor 3 in the system of FIG. 3 or in FIG. 11(a) described above.

In order to remove the instrument response and recover the deconvoluted waveform from the measured sample waveform, a reference waveform is measured. However, the characteristics of the terahertz emitter and receiver may change over time, and it may be inconvenient to take regular reference waveforms within an industrial environment, as this could involve moving the sensor to a datum point during a measurement campaign and can lead to a loss of data.

A classical Michelson interferometer configuration may be used, however, in this configuration
1. beam-splitter devices may be hard to manufacture for the terahertz region,
2. whilst the beam splitter is relatively thin (5-mm of high-resistivity silicon), it may lead to an arrangement that is not compact enough,
3. using high-resistivity silicon can lead to high insertion losses from the beam splitter alone,
4. there may also be multiple reflections from the silicon air interfaces, and
5. in an industrial environment, the orthogonal arrangement of the emitter and receiver can cause problems with high speed scanning on a production line.

The sensor 1603 described herein can overcome at least some of these problems by combining a beam-splitter and a focusing element into a linear body. This configuration may beneficial for mounting on conveyor belt type applications.

FIGS. 16(a) and 16(b) show a schematic top view and schematic side view respectively of a self-referencing sensor 1603. The sensor 1603 comprises a lens 1655, an emitter 1660, a receiver 1661, and a retro-reflector 1659. The lens 1655 is used to reflect some of the beams into the retro-reflector 1659 and back onto the terahertz receiver 1661. The retro-reflector 1659 may be used as an internal reference mirror, such as the internal reference mirror 59-b of FIG. 11(b).

In the sensor 1603, the lens 1655 comprises a wedge as shown in FIG. 16(b). The wedge is arranged such that a normal vector of the planar face of the back surface of the lens 1655 forms an angle with an optical axis defined by the convex face of the front surface of the lens 1655. In this configuration, the reflected beam from the planar face of the lens 1655 is diverted away from the optical axis and is reflected by the retro-reflector 1659 to the receiver 1661. The reflected beam can be aligned to be collinear with the beam coming from the sample 1602 onto the receiver 1661. By arranging the position of the retro-reflector 1659 to compensate for the path difference to the sample 1602, a pre-pulse on the measured waveform can be achieved.

In use, the sample 1602 is placed at the focus of the lens 1655. The emitter 1660 emits a pulse of terahertz radiation that irradiates the sample 1602. Radiation reflected from the sample 1602 is collated on the receiver 1661 by the lens 1655. A part of the emitted radiation is reflected from the back surface of the lens 1655 to the receiver 1661 via the retro-reflector 1659 and provides an internal reference pulse in the sample waveform.

The deconvoluted waveform (also referred to as the sample response herein) can be used for data analysis. For example, the deconvoluted waveform can be used to determine the refractive index and layer thickness of the sample. The deconvolution may be given by,

$${S}_{Dec} ( t ) = iFFT [ FFT ( f ( t ) ) \frac{FFT ( {s}_{c} ( t ) - b ( t ) )}{FFT ( {r}_{c} ( t ) - b ( t ) )} ] ,$$

where b(t) is the baseline pulse which can be determined at the start of measurement, f(t) is an apodisation function, r_{c}(t) is the reference pulse and S_{c}(t) is the sample pulse. The subscript ‘c’ denotes a corrected signal that has been corrected using an internal reference signal as described in more detail below. The apodisation function f(t) is a type of frequency filter that can be used to remove or suppress edge effects and thereby improve SNR. For example, f(t) can be a Tukey apodisation function set to e.g. 10% of the length of optical time delay. The reference pulse r(t) may be obtained from an external gold mirror as described above. The baseline pulse b(t) is also referred to as the background waveform and can be obtained by taking a measurement with no sample/obstruction in the path of the terahertz beam. The baseline pulse b(t), reference pulse r(t) and sample pulse s(t) all contain the internal reference pulse, which can be removed from the data before final analysis.

The external reference pulse (e.g. from the gold mirror) can be labeled as rₑ(t), and the internal reference pulse (from the retro-reflector) can be labelled as rᵢ(t). Both of the initial references (the internal and external) are measured at a first time to. To correct a sample measurement at a second (later) time t₁,

$${s}_{uc}^{{t}_{1}} ( t ) .$$

The internal reference signal provides a correction function defined by

$$\frac{{r}_{i}^{{t}_{0}} ( t )}{{r}_{i}^{{t}_{1}} ( t )} ,$$

If there is no change to the internal reference pulse, rᵢ(t), over time then

$$\frac{{r}_{i}^{{t}_{0}} ( t )}{{r}_{i}^{{t}_{1}} ( t )} = 1.$$

The corrected signal is given by

$${s}_{c} ( t ) = {s}_{uc}^{{t}_{1}} ( t ) \frac{{r}_{i}^{{t}_{0}} ( t )}{{r}_{i}^{{t}_{1}} ( t )} .$$

The reference can be corrected in a similar fashion.

FIG. 17 shows the different waveforms used in the data analysis. The background waveform b(t) comprises one peak from the internal reference mirror. The reference waveform r(t) was obtained with a gold mirror placed at the focus position of the lens and contains two peaks, the S_{R} peak

$${r}_{e}^{{t}_{0}} ( t )$$

and the internal reference mirror peak

$${r}_{i}^{{t}_{0}} ( t ) .$$

The sample was placed at the focus position to give the uncorrected sample pulse S_{UC}. The uncorrected sample waveform contains the peak from the internal reference mirror at time t₁,

$${r}_{i}^{{t}_{1}} ( t ) ,$$

as well as the sample information. The sample waveform is corrected for any changes in signal amplitude and to filter out the internal reference waveform to provide the corrected sample response, which can be used to calculate the thickness and the refractive index of the sample.

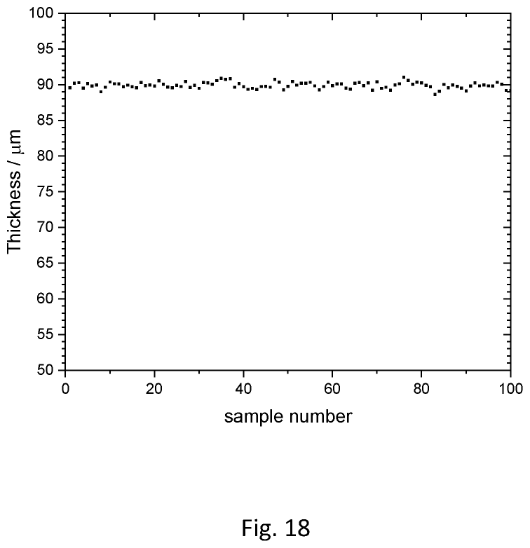

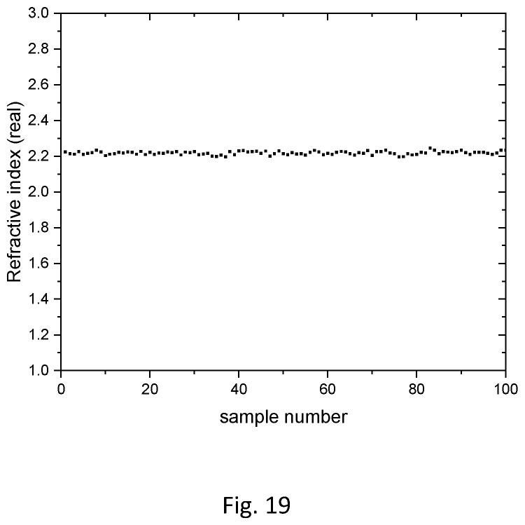

To test the sensor, an 18.5 mm focal length lens was used in a terahertz scanning system as described herein. This generated a frequency dependent focal spot of the order of 1 mm. As proof-of-concept, a Lithium Iron Phosphate (LFP) cathode on an aluminum current collector was measured 100 times and both thickness and the terahertz refractive index were calculated. The determined thickness, shown in FIG. 18, was 89.92 μm with a standard deviation of 0.44 μm and a coefficient of variation of 0.495%. The determined terahertz refractive index, shown in FIG. 19, was 2.22 with a standard deviation of 0.0096 and a coefficient of variation of 0.43%.

While certain embodiments have been described, these embodiments have been presented by way of example only, and are not intended to limit the scope of the inventions. Indeed the novel methods and apparatus described herein may be embodied in a variety of other forms; furthermore, various omissions, substitutions and changes in the form of methods and apparatus described herein may be made.

1. A method for analysing a sample comprising a layer having a first interface and a second interface, the method comprising:
irradiating the sample with a pulse of terahertz radiation, said pulse comprising a plurality of frequencies in the range from 0.01 THz to 10 THz;
detecting radiation reflected from the sample to produce a sample waveform;
obtaining a first reflection waveform from the sample waveform, the first reflection waveform corresponding to the reflection from the first interface;
obtaining a second reflection waveform from the sample waveform, the second reflection waveform corresponding to the reflection from the second interface;
comparing the first reflection waveform with the second reflection waveform to produce an estimate of a thickness and a complex refractive index of the layer;
producing a synthesised signal using the estimate of the thickness and complex refractive index;
varying at least one of the thickness and complex refractive index to reduce an error between the sample waveform and the synthesised signal; and
outputting the thickness of the layer.

2. A method according to claim 1, the method comprising:
outputting at least one of a density and a conductivity of the layer,
wherein the density and conductivity are determined from the thickness and/or complex refractive index.

3. A method according to claim 1, the method comprising:
obtaining a reference waveform,
wherein the reference waveform is obtained by irradiating a reference sample with a pulse of terahertz radiation, said pulse comprising a plurality of frequencies in the range from 0.01 THz to 10 THz, and detecting radiation reflected from the reference sample to produce a reference waveform.

4. A method according to claim 1, wherein:
obtaining the first reflection waveform and the second reflection waveform from the sample waveform comprises using time-gating.

5. A method according to claim 4, wherein the first reflection waveform is transformed to the frequency domain to obtain a first spectrum, and the second reflection waveform is transformed to the frequency domain to obtain a second spectrum.

6. A method according to claim 3, the method comprising:
deconvolving the sample waveform with the reference waveform to produce a deconvolved waveform;
time-gating the deconvolved waveform to obtain the first reflection waveform and the second reflection waveform;
transforming the first reflection waveform to the frequency domain to obtain a first spectrum; and,
transforming the second reflection waveform to the frequency domain to obtain a second spectrum.

7. A method according to claim 6, the method comprising:
determining an estimate of the thickness and the complex refractive index from the first spectrum and/or the second spectrum, wherein the complex refractive index is frequency dependent.

8. A method according to claim 7, the method comprising:
transforming the reference waveform to the frequency domain to obtain a reference spectrum;
determining an estimate of the real part of the complex refractive index from the reference spectrum and the first spectrum.

9. A method according to claim 7, the method comprising:
obtaining the second reflection spectrum;
correcting the second reflection spectrum;
determining the imaginary part of the refractive index from the corrected second reflection spectrum; and
determining the thickness from the corrected second reflection spectrum.

10. A method according to claim 7, method comprising:
fitting the estimate of the complex refractive index to a physical model, to produce a model of the layer.

11. A method according to claim 10, wherein varying the complex refractive index to reduce an error between the sample waveform and the synthesised signal comprises varying parameters of the model, wherein the parameters of the model are related to the complex refractive index.

12. A method according to claim 3 comprising:
determining a magnitude of the first reflection waveform;
comparing the magnitude of the first reflection waveform with a magnitude of the reference waveform to produce a first ratio; and
estimating a real part of the complex refractive index using the first ratio.

13. A method according to claim 12 comprising:
determining a magnitude of the second reflection waveform;
comparing the magnitude of the first reflection waveform with the magnitude of the second reflection waveform to produce a second ratio; and
estimating an imaginary part of the complex refractive index using the second ratio.

14. A method according to claim 12, comprising:
comparing the first reflection waveform and the second reflection waveform to obtain a time delay; and
estimating the thickness using the time delay, or using the time delay combined with refractive index information.

15. A system for analysing a sample comprising a layer having a first interface and a second interface, the system comprising:
a sensor, the sensor comprising a pulsed source of terahertz radiation adapted to irradiate the sample with a pulse of terahertz radiation, said pulse comprising a plurality of frequencies in the range from 0.01 THz to 10 THz, and a detector for detecting reflected radiation to produce a sample waveform, said sample waveform being derived from the reflected radiation; and an analysis unit, said analysis unit comprising a processor and a memory, said processor adapted to:
obtain a first reflection waveform from the sample waveform, the first reflection waveform corresponding to the reflection from the first interface;
obtain a second reflection waveform from the sample waveform, the second reflection waveform corresponding to the reflection from the second interface;
compare the first reflection waveform with the second reflection waveform to produce an estimate of a thickness and a complex refractive index of the layer;
produce a synthesised signal using the estimate of the thickness and complex refractive index;
vary at least one of the thickness and complex refractive index to reduce an error between the sample waveform and the synthesised signal; and
output the thickness of the layer.

16. A system for analysing a sample comprising a layer having a first interface and a second interface, the system comprising:
a sensor, the sensor comprising a pulsed source of terahertz radiation adapted to irradiate the sample with a pulse of terahertz radiation, said pulse comprising a plurality of frequencies in the range from 0.01 THz to 10 THz, and a detector for detecting reflected radiation to produce a sample waveform, said sample waveform being derived from the reflected radiation;
wherein the sensor comprises an optical element adapted to resolve reflected radiation from both the first interface and the second interface.

17. A system according to claim 16, wherein the optical element comprises a f-number of 3 or more.

18. A system according to claim 17, wherein the optical element comprises a f-number of 10 or more.

19. A method for adapting a system for analysing a sample comprising a layer having a first interface and a second interface, the system comprising a sensor, the sensor comprising a pulsed source of terahertz radiation adapted to irradiate the sample with a pulse of terahertz radiation, said pulse a plurality of frequencies in the range from 0.01 THz to 10 THz, a detector for detecting reflected radiation, and an optical element,
the method comprising:
obtaining an estimate of the refractive index of the layer;
obtaining an estimate of the thickness of the layer; and
determining a f-number of the optical element such that the confocal parameter, scaled by the estimate of the refractive index, is greater than the estimate of the thickness of the layer.

20. A process for manufacturing an electrode for a battery, the process comprising:
coating a substrate with a layer;
drying the coated layer; and
calendaring the dried layer;
the process further comprising:
analysing the layer using the method according to claim 1, wherein the layer is analysed at any one or more of: before drying the layer, after drying the layer, before calendaring the dried layer, and after calendaring the dried layer; and
adjusting process conditions for any one or more of the steps of: coating a substrate with a layer; drying the layer; and calendaring the dried layer.

21. A sensor for analysing a sample comprising a layer having a first interface and a second interface, the sensor comprising:
a pulsed source of terahertz radiation adapted to generate a pulse of terahertz radiation, said pulse comprising a plurality of frequencies in the range from 0.01 THz to 10 THz;
a focussing element configured to direct the generated pulse of terahertz radiation towards a sample using a first path, and to direct the pulse of terahertz radiation towards an internal mirror using a second path; and,
a detector for detecting reflected radiation to produce a sample waveform, wherein the sample waveform comprises radiation reflected from the sample via the first path, and radiation reflected from the internal mirror via the second path.

22. A sensor according to claim 21, wherein the focussing element and internal mirror are configured such that the second path is shorter than the first path.

23. A sensor according to claim 22, wherein the focussing element and the internal mirror are movable relative to one another such that length of the second path is adjustable.

24. A sensor according to claim 21, wherein:
the focussing element comprises a front surface and a back surface,
wherein the front surface comprises a convex face, and the back surface comprises a planar face, and wherein,
in use, the front surface faces towards the sample and the back surface faces away from the sample,

25. A sensor according to claim 24 wherein a normal vector of the planar face of the back surface forms an angle with an optical axis defined by the convex face of the front surface.
